(19) United States
(12) Patent Application Publication
(10) Pub. No.: US 2025/0279522 A1
(43) Pub. Date: Sep. 4, 2025

(54) PROTECTIVE ELEMENT, SET OF COMPONENTS AND METHOD FOR PRODUCING THE PROTECTIVE ELEMENT

(71) Applicant: ElringKlinger AG, Dettingen (DE)

(72) Inventors: Robert WITZGALL, Reutlingen (DE); Fabian ALBRECHT, Kirchheim (DE); Thomas WOLF, Göppingen (DE); Matthias BIEGERL, Neuffen (DE); Eugen KÜBLER, Owen (DE)

(73) Assignee: ElringKlinger AG, Dettingen (DE)

(21) Appl. No.: 19/212,947

(22) Filed: May 20, 2025

Related U.S. Application Data
(63) Continuation of application No. PCT/EP2023/082416, filed on Nov. 20, 2023.

(30) Foreign Application Priority Data
Nov. 21, 2022 (DE) 10 2022 130 663.1

(51) Int. Cl. H01M 50/24; B60L 50/64; H01M 50/229; H01M 50/231; H01M 50/242; H01M 50/249

(52) U.S. Cl. CPC H01M 50/24; B60L 50/64; H01M 50/229; H01M 50/231; H01M 50/242; H01M 50/249; H01M 2220/20

(57) ABSTRACT

A protective element for arrangement on a device which emits electromagnetic radiation, wherein the device can be, for example, an at least partially electrically powered motor vehicle, the protective element comprising the following: a shielding layer for shielding against electromagnetic radiation, a plastic layer, and a contacting zone via an electrical contact can be established between the shielding layer and the device.

### RELATED APPLICATION

This application is a continuation of international application No. PCT/EP2023/082416 filed on Nov. 20, 2023, and claims the benefit of German application No. 10 2022 130 663.1 filed on Nov. 21, 2022, which are incorporated herein by reference in their entirety and for all purposes.

### FIELD OF DISCLOSURE

The present invention pertains to the field of protective elements, more particularly of EMC protective elements.

Electromagnetic compatibility (EMC) denotes the absence of interference to electrical or electronic apparatuses caused by its environment.

### BACKGROUND

Modern motor vehicles are at least partially electrically powered. Furthermore, increasing numbers of devices that communicate by way of electromagnetic waves are being integrated into motor vehicles or utilized in motor vehicles. Securing the EMC is consequently becoming a growing challenge.

In at least partially electrically powered motor vehicles, particularly in the region around the battery, there is additionally a requirement to ensure a protective function against external effects such as stone impact, and to ensure integrity in the event of thermal runaway in battery cells.

This is to be made possible with minimal component weights, so that the weight of the motor vehicle is increased only to a minor extent or not at all.

### SUMMARY OF THE INVENTION

It is an object of the present invention to provide an effective protective element at low cost and complexity. The protective element preferably may be (as far as possible) universally employable for the securement of the EMC and/or may offer protection against stone impact and/or protection against thermal runaway in a battery cell. It may be particularly advantageous if the protective element is advantageous overall, taking account of production cost and complexity, securement of the EMC, protection against stone impact and protection against thermal runaway in battery cells.

The object is achieved in accordance with the invention by the features of claim 1.

The device which emits electromagnetic radiation may be, for example, an at least partially electrically powered motor vehicle.

The device, for example the at least partially electrically powered motor vehicle, preferably comprises an electrochemical unit for providing electrical energy serving to propel the motor vehicle. The electrochemical unit may preferably be a battery unit or a fuel cell unit.

The device, for example the at least partially electrically powered motor vehicle, preferably comprises one or more electrical machines which serve to propel the motor vehicle.

Within the device, such as within the at least partially electrically powered motor vehicle, the electromagnetic radiation may be emitted by the electrochemical unit and/or by the one or more electrical machines or else by other components of the device.

The protective element comprises a shielding layer for shielding from electromagnetic radiation. Shielding layers suitable for shielding from electromagnetic radiation are familiar to those skilled in the art from the technical field of electromagnetic compatibility.

The thickness of the shielding layer may be, for example, 0.01% to 50% of the wall thickness of the protective element. In the case in particular of protective elements of low surface area, which are subject to little mechanical stress, even a very thin shielding layer may account for a high proportion of 50%, for example, of the wall thickness of the protective element. Conversely, in the case of protective elements of very high surface area, which may be subject to severe mechanical stress, as in the case of underbody protective elements, for example, a substantial wall thickness may be rational. In that case it may oftentimes be completely sufficient for the shielding layer to account only for a very low proportion of 0.01%, for example, of the wall thickness of the protective element. It may be preferable if the thickness of the shielding layer is 0.5% to 20% of the wall thickness of the protective element. It may be particularly preferable if the thickness of the shielding layer is 0.8% to 15% of the wall thickness of the protective element.

The thickness of the shielding layer may advantageously be 0.01 to 3 mm. It may be preferable if the thickness of the shielding layer is 0.02 to 1 mm. It may be particularly preferable if the thickness of the shielding layer is 0.03 to 0.3 mm.

The wall thickness of the protective element may advantageously be 1 mm to 5 cm. It may be preferable if the wall thickness of the protective element is 1.5 mm to 2.5 cm. It may be particularly advantageous if the wall thickness of the protective element is 2 to 8 mm. In the case in particular of protective elements of low surface area, which are exposed only to low mechanical stresses, very low wall thicknesses may be sufficient. Conversely, high wall thicknesses may be particularly advantageous in the case of protective elements of high surface area, which are exposed to relatively high mechanical stresses.

Materials suitable for shielding layers are familiar to those skilled in the art. The shielding layer may advantageously comprise: a metal; and/or an electrically conductive carbon; and/or a carrier layer comprising an electrically conductive layer.

The electrically conductive carbon may be, for example, a graphite or a carbon fiber. The carrier layer may be, for example, a plastic film or a plastic nonwoven, e.g. a PET nonwoven. Polyethylene terephthalate is referred to in abbreviated form as PET. The electrically conductive layer may be an aluminum coating, copper coating, NiCo coating or silver coating applied to the carrier layer.

It is particularly advantageous if the shielding layer comprises a metal. The metal may comprise, for example, aluminum, copper, iron and/or silver.

The metal may be in any suitable form in the shielding layer.

The metal in the shielding layer may preferably be present as a metal foil, metal mesh and/or as a metal nonwoven.

The shielding layer may for example be selected from:
aluminum foils,
aluminum meshes,
stainless steel meshes,
bronze meshes,
copper meshes,
plastic nonwovens (e.g. PET nonwovens), with applied aluminum film,
plastic nonwovens (e.g. PET nonwovens), coated with copper on one side,
unidirectional tapes containing carbon fiber,
nonwovens made from recycled carbon fibers,
graphite foils,
polymers (e.g. polypropylenes) combined with an aluminum mesh.

It may be particularly preferable if the shielding layer comprises a metal foil.

It may be especially preferable if the shielding layer comprises aluminum.

Hence the shielding layer may be, for example, an aluminum foil or an aluminum sheet, with the thickness of the shielding layer being preferably 0.02 to 1 mm, e.g. 0.03 to 0.3 mm.

In trials it was found surprisingly that aluminum foil enabled much better shielding effectiveness in the frequency range from 0.01 to 1000 MHz than aluminum meshes of comparable thickness and than copper, bronze or stainless steel.

It may be preferable if the shielding layer comprises regularly spaced openings.

The shielding layer may have multiple plies. A first ply, preferably first metal ply, e.g. first aluminum ply, of the shielding layer may preferably comprise regularly spaced openings, and a second ply, preferably second metal ply, e.g. second aluminum ply, of the shielding layer may preferably have regularly spaced openings, in which case a spacing of the openings in the second ply is different than a spacing of the openings in the first ply. This may be achieved, for example, by meshes or grids having different mesh sizes, or by corrugated foils.

The protective element comprises a plastic layer. The plastic contained in the plastic layer is preferably a thermoplastic.

The plastic layer and the shielding layer may be connected to one another indirectly or directly. They are connected to one another indirectly if there is at least one further layer between the plastic layer and the shielding layer.

The plastic layer and the shielding layer preferably form layers of a layered assembly. The protective element is preferably a layered assembly element.

It may be advantageous if an adhesion promoter is arranged, in the form of an adhesion promoter coating, for example, between shielding layer and plastic layer, for example on a surface of the shielding layer that faces the plastic layer.

It may be particularly advantageous if the shielding layer is a metal foil or a metal sheet, more particularly is an aluminum foil or an aluminum sheet, and the adhesion promoter is arranged between the shielding layer and the plastic layer on a surface of the shielding layer that faces the plastic layer.

The adhesion promoter is preferably selected from adhesion promoters which boost the adhesion on the surface of the shielding layer.

The adhesion promoter is preferably selected from adhesion promoters which boost the adhesion of plastics on the surface of the shielding layer.

The adhesion promoter is preferably selected from adhesion promoters which boost the adhesion of the plastic of the plastic layer on the surface of the shielding layer.

The protective element may preferably comprise an electrically insulating protective layer.

It may be particularly advantageous if the shielding layer is arranged between the plastic layer and the electrically insulating protective layer.

The statement that a layer is arranged between other layers allows for further interlayers. For example, there may thus be one or more reinforcing layers between the shielding layer and the plastic layer.

Reinforcing layers are addressed in detail elsewhere herein.

An effect of the electrically insulating protective layer may be that in the event of malfunction of a battery unit or a battery cell arranged in the vicinity of the shielding layer, no short-circuiting occurs. Those skilled in the art from the field of battery housings are familiar with suitable electrically insulating materials which can be applied as an electrically insulating protective layer.

The protective element comprises a contacting zone by means of which electrical contact can be produced between the shielding layer and the device. The contacting zone may preferably be a surface of the shielding layer.

The electrical contact which can be produced between the contacting zone and the device may be a direct electrical contact or an indirect electrical contact between the surface of the shielding layer and the device. If the contact is an indirect contact, the contact may be an electrical contact bridgeable by a bridging element between the shielding layer and the device.

It may be particularly advantageous if the protective element comprises a contacting element.

By means of the contacting element, preferably, electrical contact, more particularly direct or indirect electrical contact, can be producible or stabilizable between the contacting zone and the device.

By means of the contacting element, for example, direct electrical contact can be producible or stabilizable between the contacting zone and the device.

In the region of the contacting zone, the contacting element here may have been pressed from an inner region of the protective element onto the shielding layer. As a result, in the region of the contacting zone, the shielding layer may be supported from an inner region of the protective element such that an outer surface of the shielding layer, which may be the contacting zone, can be pressed firmly onto the device. For example, a protrusion element described herein may have been pressed onto the shielding layer, so that the contacting zone at that location (e.g. locally) curves toward the device, which may make it possible to produce more stable electrical contact to the device. The contacting element may in that case be electrically conductive or electrically insulating. Indeed, it may promote the production or stabilization of direct electrical contact between the shielding layer and the device substantially through a supporting effect. The contacting element in that case need not itself conduct electrical current.

Electrical contact bridged by the contacting element can preferably be producible between the contacting zone and the device. For example, a surface of the contacting element may be in electrically conductive contact with the contacting zone, which may be a surface of the shielding layer, for example, and a further surface of the contacting element may be able to be brought into electrically conductive contact with the device. In that case, the contacting element is electrically conductive.

It may be particularly advantageous if the contacting element is deformable and/or elastic.

It may be particularly advantageous if the contacting element comprises fibers and/or a fibrous material.

The contacting element and/or fibers of the contacting element and/or the fibrous material of the contacting element may advantageously extend wholly or partially around a compression zone. An example of what may be interpreted as a compression zone is a cavity which may extend, for example, in the contacting element. The compression zone and/or the cavity may preferably be compressed and/or squashed in an assembly direction on assembly of the protective element.

The contacting element may for example be a hollow contacting element through which the compression zone extends. It may be advantageous if the contacting element is a fibrous material hose, e.g. a woven fabric hose.

Even if it is deformable and/or elastic and/or comprises the fibers and/or the fibrous material, the contacting element of course preferably comprises a sufficiently electrically conductive material, so that electrical contact between the contacting zone and the device can be producible or stabilizable by means of the contacting element.

It may be advantageous if the protective element comprises a positioning and/or aligning element, which may for example be or comprise a positioning and/or aligning projection.

At least one portion of the positioning and/or aligning element advantageously can be arranged on at least one portion of the contacting zone.

It may be advantageous if at least one portion of the contacting element, preferably of the fibrous material hose, e.g. of the woven fabric hose, is arranged on the positioning and/or aligning element, e.g. on the positioning and/or aligning projection, and/or if at least one portion of the contacting element, preferably of the fibrous material hose, e.g. of the woven fabric hose, is arranged on the contacting zone.

This may be advantageous as the contacting element can thus be held in the desired position in a particularly simple way.

A fibrous material hose, e.g. a woven fabric hose, may preferably be fluid-permeable through its walls.

The contacting element may preferably be annular. The annular contacting element may be a sleeve. A form of this kind may be advantageous, as a connecting element, e.g. a screw, may be guided through the opening in the annular contacting element or in the sleeve in order to secure the protective element on the device.

Advantageously, at least part of the contacting element may be materially bonded with the plastic layer and/or at least part of the contacting element may be incorporated in the plastic layer. This may be brought about, for example, in a particularly elegant way by positioning the contacting element at the desired point in the shaping process so that a plastic material, e.g. a plastic melt, can spread around the contacting element and incorporate the contacting element into the resultant plastic layer.

The shielding layer may preferably comprise a shielding layer overhang.

It may be advantageous if the shielding layer overhang comprises the contacting zone.

The shielding layer on the shielding layer overhang is preferably not covered by the plastic layer and/or, if the protective element is embedded between the plastic layer and a further layer, e.g. a further plastic layer, the shielding layer is preferably not covered by at least one of these two layers.

At least part of the shielding layer overhang may extend in a different direction than a part of the shielding layer that is covered by the plastic layer. For example, at least part of the shielding layer overhang may be in contact with an outer lateral surface of the annular contacting element. At least part of the shielding layer overhang may have been pressed onto the lateral surface, have for example been pressed through a surrounding plastic layer.

The contacting element may comprise a protrusion element.

The protrusion element may preferably face the contacting zone comprised by the shielding layer, e.g. the contacting zone comprised by the shielding layer overhang.

The protrusion element may extend through the shielding layer on the contacting zone. It may, for example, penetrate the shielding layer.

It may be advantageous if the protective element on both sides of the shielding layer comprises respectively at least one contacting element or one part of a contacting element.

The contacting zone is arranged preferably in an edge zone of the protective element. The edge zone may, for example, adjoin a wall zone of the protective element.

In the transition from the wall zone into the edge zone, the protective element may have a kink or a curve. Alternatively or additionally, a layer structure of the protective element may be different in an edge zone than in a zone adjoining the edge zone.

A plurality of contacting zones spaced apart from one another may be arranged in the edge zone.

A contacting zone extending along the edge zone may be arranged in the edge zone.

The shielding layer may be wholly or partially embedded. It may be wholly or partially embedded between the plastic layer and a further layer. The further layer may preferably be a further plastic layer, a reinforcing layer, an electrically insulating protective layer and/or a high-temperature thermal insulation layer. The further layer may extend, for example, up to the edge zone, without concealing the edge zone.

It may be preferable if the electrical contact can be produced between the shielding layer and a frame or a carrier structure comprised by the device. The frame and/or the carrier structure may be comprised by the mass of the device. In the case of motor vehicles, the mass potential is the carrier structure comprising bodywork and frame. The term “mass” used in this context refers to this mass potential.

It may be preferable if the contacting zone is configured on a shielding layer end face.

As the shielding layer is in layer form, the shielding layer comprises not only two main surfaces but also an encircling end face.

It may be particularly advantageous if the shielding layer comprises a passage opening. The passage opening may preferably align with an opening in the annular contacting element. The opening in the annular contacting element may be the opening which passes through the annular contacting element.

The passage opening may comprise a shielding layer end face encircling the passage opening, and the contacting zone may be a contacting zone configured on the encircling shielding layer end face, e.g. an inner-surface contacting zone.

This may be particularly advantageous as a contacting element may be introduced into the passage opening and electrical contact between the shielding layer and the device can be produced via the contacting element. The contacting element may for example be a connecting element, in particular a screw. The thread of the connecting element may engage, for example, into a counterthread in a frame of the device and may thereby ensure electrical contact with the device as well.

Preferably, a distance of each contacting zone to the most closely adjacent contacting zone is at most 300 mm, preferably at most 200 mm, more preferably at most 100 mm. It may be particularly advantageous if a distance of each contacting zone to the most closely adjacent contacting zone is for example at most 50 mm, preferably at most 30 mm, more preferably at most 20 mm. This is the case especially for distances between inner-surface contacting zones.

It may be particularly advantageous if the contacting zone is an outer-surface contacting zone, with the outer-surface contacting zone being configured on an outer surface of the shielding layer.

An outer-surface contacting zone configured on an outer surface of the shielding layer may be present in particular when the shielding layer in the region of the contacting zone forms a capping layer of the protective element.

A layer referred to herein as a capping layer is always the layer which forms a concluding layer in the layer structure of the protective element. In that case, one of the main surfaces of the capping layer forms one of the main surfaces of the protective element.

An outer surface of the protective element is understood herein to be, in particular, an outer surface of the protective element that extends parallel to the layered assembly planes of the protective element.

An outer surface of the shielding layer is understood herein to be, in particular, an outer surface of the shielding layer that extends parallel to the layered assembly planes of the protective element and is preferably also an outer surface of the protective element.

The protective element may preferably comprise an offset zone. In the offset zone, the shielding layer may preferably extend in a different direction than in the contacting zone.

It may be advantageous if the shielding layer in the contacting zone forms a capping layer of the protective element. The contacting zone in that case may in particular be an outer-surface contacting zone.

In a further zone, separated from the contacting zone by the offset zone, a layer of the protective element that is different from the shielding layer may form a capping layer of the protective element. The further zone which is separated from the contacting zone by the offset zone may be an insulating zone, for example.

The layer of the protective element that is different from the shielding layer and that forms the capping layer of the protective element in the further zone may be, for example, the electrically insulating protective layer described herein.

This can be particularly advantageous, as in the insulation zone, in the event of abnormal behavior of a battery, in the case of thermal runaway of a battery cell, for example, the electrically insulating protective layer can prevent short-circuits. At the same time, however, in the region of the contacting zone, the shielding layer may be available for electrical contacting. This makes it possible to ensure improved shielding from electromagnetic rays which may be emitted by the battery in regular operation.

It may be advantageous if the protective element is fiber-reinforced.

The protective element may be fiber-reinforced, for example, in that the shielding layer, the plastic layer and/or the electrically insulating protective layer comprise fibers.

It may be advantageous if the plastic layer comprises fibers.

The fibers may be dispersed in a plastic material of the plastic layer, in which case the plastic material is preferably a thermoplastic material. A mean length of the fibers may be preferably 1 mm to 40 mm, e.g. 2 mm to 20 mm. The fibers may be ground fibers, preferably recycled fibers, e.g. recycled carbon fibers. The plastic material may form a plastic matrix in which the dispersed fibers are distributed.

It is particularly preferable if the protective element comprises a reinforcing layer.

The reinforcing layer may preferably comprise a laid fiber scrim or a woven fiber fabric. The laid fiber scrim may be, for example, a uniaxial or a multiaxial scrim.

The reinforcing layer may be a metallic reinforcing layer, which for example may comprise a further aluminum sheet or a further aluminum foil. In general this is less preferable.

The plastic layer may be a reinforcing layer. In general this is less preferable. A preferred protective element comprises the reinforcing layer in addition to the plastic layer.

The plastic layer is preferably thicker than the reinforcing layer. The thickness of the plastic layer may be at least twice the thickness of the reinforcing layer. If a plurality of reinforcing layers are present, the thickness of the plastic layer may be at least twice the thickness of the thickest reinforcing layer.

The plastic layer may be foamed. Substances which promote foaming of plastics are familiar to those skilled in the art.

It may be particularly advantageous if the protective element is a protective sandwich element. The protective sandwich element preferably has a respective reinforcing layer on both surfaces. The two reinforcing layers may independently of one another preferably comprise a laid fiber scrim or a woven fiber fabric. The laid fiber scrim may be, for example, a uniaxial or a multiaxial scrim.

It may be particularly advantageous if the protective sandwich element has at least one respective reinforcing layer on both surfaces of the plastic layer. The two reinforcing layers may independently of one another preferably comprise a laid fiber scrim or woven fiber fabric. The laid fiber scrim may be, for example, a uniaxial or a multiaxial scrim.

The shielding layer may advantageously run at least in one portion of the protective sandwich element between the plastic layer and a reinforcing layer or between two reinforcing layers which are arranged on one side of the plastic layer.

It may be particularly advantageous if the protective element comprises a high-temperature thermal insulation layer.

The term “high-temperature” refers in this context to the temperatures which may arise in the event of battery cell runaway. They may be in a temperature range from 1000 to 1200° C. In the event of thermal runaway of a battery cell, for example, gases with a temperature of about 1100° C. may emanate from the battery cell. In addition to the thermal loading, an abrasive effect may occur. This effect derives from a particle flow. Indeed, together with hot gases, hot particles as well emanate from the battery cell experiencing runaway.

The high-temperature thermal insulation layer preferably withstands the abrasive stream of hot gas for as long as possible.

It may be advantageous if the high-temperature thermal insulation layer comprises a hot gas barrier.

The hot gas barrier may comprise a mineral barrier material.

The mineral barrier material may be selected from mica and mineral fibers, preferably from glass fibers and ceramic fibers, e.g. from glass fibers.

Alternatively or additionally, the hot gas barrier may comprise an organic barrier material.

The organic barrier material may preferably be a meta-aramid material, e.g. a laid meta-aramid scrim or a woven meta-aramid fabric. Organic barrier materials of these kinds are marketed by DuPont under the brand name Nomex®.

The organic barrier material may preferably comprise carbon fibers. The organic barrier material may comprise, for example, a regular or an irregular fabric which comprises carbon fibers or is produced from carbon fibers. The regular fabric may preferably be a woven fabric comprising carbon fibers. The irregular fabric may preferably be a nonwoven comprising carbon fibers or a paper comprising carbon fibers. The regular fabric may be, for example, a woven carbon fiber fabric. The irregular fabric may preferably be a carbon fiber nonwoven or a carbon fiber paper.

It may be particularly advantageous if the hot gas barrier comprises a woven glass fiber fabric.

The use of a woven glass fiber fabric may be particularly advantageous as lateral blowing of fibers by the hot gas stream is prevented in such a fabric. Lateral blowing of the fibers is prevented in particular by the fibers running transversely in the woven fabric in each case. This structure may considerably retard the passage of the flame and/or of the hot gases.

It may be advantageous if the mineral barrier material comprises ceramic fibers. The hot gas barrier may comprise, for example, a nonwoven containing ceramic fibers, e.g. a ceramic nonwoven.

It may be especially advantageous if the hot gas barrier comprises a plurality of mineral barrier materials or comprises a mineral barrier material and an organic barrier material. Hence the hot gas barrier may comprise, for example, a woven glass fiber fabric with mica arranged thereon or a woven glass fiber fabric with additional meta-aramid fiber reinforcement.

The protective element may be curved.

The protective element may have one convex and one concave surface. The electrically insulating protective layer and/or the high-temperature thermal isolation layer may preferably form a capping layer of the protective element in a concave region. The electrically insulating protective layer and/or the high-temperature thermal insulation layer may form an inner lining of the protective element. The protective element may in that case serve in particular as a battery housing part, in which case a part of the battery may extend into the concave region of the protective element.

It may be advantageous if the protective element comprises a protrusion zone, with the protrusion zone protruding from a surface of the protective element and defining the contacting zone. The shielding layer in the protrusion zone preferably protrudes from the surface of the protective element.

It may be particularly advantageous if the shielding layer in the protrusion zone comprises a bead and the bead protrudes from the surface of the protective element.

The protective element may comprise an electrically conductive discharge element integrated into the protective element, with the electrically conductive discharge element being in electrically conductive contact with the contacting zone. The electrically conductive discharge element may be, for example, an electrically conductive sleeve. In that case, the contacting zone may in particular be an inner-surface contacting zone encircling a passage opening. On the contacting zone, e.g. on the inner-surface contacting zone which encircles the passage opening, the shielding layer may be concealed with an electrically insulating capping layer. In that case, the electrically conductive discharge element, e.g. the electrically conductive sleeve, may extend at least partially through the electrically insulating capping layer. An electrically insulating capping layer may be, for example, a reinforcing layer.

It may be preferable if the shielding layer comprises a shielding deflection zone, wherein two portions of the shielding layer overlap in the shielding deflection zone, and one of the two portions forms the contacting zone. The contacting zone may be, for example, an outer-surface contacting zone.

With preference, one of the two overlapping portions of the shielding layer may extend along a concave zone of the protective element, and the other of the two overlapping portions of the shielding layer may extend along a convex counterzone of the protective element, with the convex counterzone being arranged in the concave zone.

The protective element may be obtained at least partially by compression molding. The protective element may in particular be obtained at least partially by the compression molding method described herein.

The protective element may be obtained at least partially by injection molding. The protective element may in particular be obtained at least partially by an injection molding method described herein.

The object is also achieved in accordance with the invention by the component set according to the relevant independent claim.

The component set comprises a contacting element which is in electrically conductive contact with the contacting zone.

The contacting element is a loose component which is different from the shielding layer and is detachable from the protective element. It differs from the electrically conductive discharge element described herein and integrated into the protective element. The protective element integrated into the electrically conductive discharge element is deemed to be part of the protective element, as it does not constitute an independent component detachable from the protective element.

The contacting element may preferably be a connecting element. This may be particularly advantageous, as a contacting element which is also a connecting element not only is able to produce electrically conductive contact with the contacting zone but also additionally is able to produce a connection to the mass comprised by the device. The connecting element may be, for example, a screw, a bolt, a nut, a rivet and/or a snap connection element.

A particularly preferred connecting element is a screw. The screw may in particular be a flow-hole screw.

The contacting element may be annular. The annular contacting element may preferably be a sleeve.

It may be advantageous if the contacting element comprises a protrusion element facing the shielding layer. It may be particularly preferable if the contacting element comprises a plurality of protrusion elements facing the shielding layer. The protrusion elements may be arranged, for example, on the end face of a contacting element, more particularly on the end face of a contacting element which is a sleeve. The protrusion elements may be distributed on the end face around an opening which extends through the sleeve. The number of protrusion elements may for example be at least three. The at least three protrusion elements may be distributed on the end face at an equal distance from each other around the opening which extends through the sleeve.

It may be particularly advantageous if the protrusion element facing the shielding layer mediates electrically conductive contact from an outer surface of the shielding layer to the contacting element when the outer surface of the shielding layer is pressed onto the contacting element.

The protrusion element may be advantageous as it is able to produce an electrically conductive contact in particular also via passivated surface regions or adhesion promoter located on the surface. This may be advantageous in particular in the production of the protective element, as when attaching adhesion promoters on the shielding layer, for example on the aluminum foil, for instance, the regions of the shielding layer that are intended to form outer-surface contacting zones do not have to be kept free of adhesion promoter. For that it would be necessary, during the application of adhesion promoter, to employ masks or the like which prevent application of adhesion promoter in the regions of later outer-surface contacting zones. That would entail considerable extra cost and complexity.

On the outer surface of the shielding layer, advantageously, an adhesion promoter may be arranged and the protrusion element facing the shielding layer may mediate the electrically conductive contact from the outer surface of the shielding layer to the contacting element by perforating the adhesion promoter.

The protrusion element perforates the adhesion promoters in particular when the outer surface of the shielding layer is pressed onto the contacting element.

The protrusion element may in particular be an elevation consisting of an electrically conductive material. The elevation may extend with a taper from one surface of the contacting element. The elevation may in particular extend with a taper from one surface of the contacting element and run to a point.

The contacting element may comprise a protrusion element facing away from the shielding layer. It may be particularly preferable if the contacting element comprises a protrusion element facing the shielding layer and a protrusion element facing away from the shielding layer.

The contacting element may comprise mutually opposing contacting element surfaces, with at least one respective protrusion element being arranged on the two surfaces.

The protrusion element facing away from the shielding layer may mediate electrically conductive contact of the contacting element to a mass, e.g. to the bodywork or to the frame of the motor vehicle, when the contacting element is pressed onto the mass. In particular, the protrusion element facing away from the shielding layer may mediate the electrically conductive contact from the contacting element to the mass when the contacting element is inserted between the mass and an outer surface of the shielding layer. The protrusion element facing away from the shielding layer may promote electrically conductive contact also via a means attached on the surface of the mass, in which case the means may be an anticorrosion means, for example. The protrusion element may perforate the means, e.g. the anticorrosion means, and thereby promote the electrically conductive contact.

The object is also achieved in accordance with the invention by a method according to the relevant independent claim.

A ply of a shielding material is provided and a plastic layer is formed in the layered assembly with the shielding material. This may mean that the plastic layer is formed directly on the surface of the shielding material. It may also mean that at least one further connecting layer, e.g. a reinforcing layer, is present or is formed between the surface of the shielding material and the plastic layer.

The shielding material is at least partially reshaped prior to the formation of the plastic layer; and/or at least partially reshaped during the formation of the plastic layer; and/or at least partially reshaped after the formation of the plastic layer in the layered assembly.

The plastic layer may be produced for example by compression molding, by injection molding or by sprayed application.

Optionally a further layer is formed in the layered assembly with the shielding material concurrently with the formation of the plastic layer, temporally overlapping the formation of the plastic layer or temporally offset from the formation of the plastic layer.

Especially if the method comprises a compression molding method, the optional further layer may be formed, for example, from a reinforcing ply and may be a reinforcing layer. In that case, for example, a plastic serving to form the plastic layer may be arranged between the ply of the shielding material and the reinforcing ply.

Especially if the method comprises an injection molding method, the optional further layer may be, for example, a further plastic layer. The further plastic layer may preferably be formed temporally overlapping the formation of the plastic layer or temporally offset from the formation of the plastic layer.

A contacting zone is formed by means of which electrical contact can be produced between the shielding layer formed from the shielding material and the device which emits electromagnetic radiation.

An outer-surface contacting zone, for example, may be formed, wherein an offset zone is formed by reshaping of the shielding material, wherein the shielding layer in the offset zone extends preferably in a different direction than in the outer-surface contacting zone. An inner-surface contacting zone, for example, may be formed. The inner-surface contacting zone may be formed, for example, by the production of a passage opening. The passage opening extends preferably through the shielding layer.

During the formation of the plastic layer, it is preferably possible for the contacting element, preferably the annular contacting element, the sleeve for example, to be embedded at least partially into the resultant plastic layer, wherein the contacting element may be arranged preferably on a surface of the shielding material at a point where the contacting zone is prelocated or is formed. It may be particularly preferable for the contacting element to be positioned at a desired point and only then for the front of a spreading plastic melt to be conveyed there, so that the plastic spreads around the contacting element and embeds the contacting element.

It may be advantageous if the contacting zone is formed or modified with a die element and/or a punch element.

It may be particularly advantageous if the contacting element is held with the die element on the surface of the shielding material, and/or the contacting element is pressed with the die element against the surface of the shielding material. In that case, with the die element, e.g. at least one protrusion element can be pressed against the surface of the shielding material, can be impressed into the surface of the shielding material or can be pressed through the shielding material.

It may be particularly advantageous if the contacting element is accommodated wholly or partially, preferably partially, in a recess in a mold half of a shaping tool, to be positioned at the desired point.

It may be advantageous if the passage opening is formed or modified with the punch element.

It may be particularly preferable if at least one die element and/or at least one punch element is guided in a shaping tool. The at least one die element and/or the at least one punch element may preferably be guided in a mold half of the shaping tool, e.g. in at least one dedicated guiding zone of the shaping tool.

An effect of this may be that the entire protective element is generated substantially completely in one operation or even in one shaping tool, including precisely positioned contacting elements and exactly defined contacting zones. As a result, ultimately, a particularly effective protective element can be provided with the minimum of cost and complexity.

The method may comprise a compression molding method, wherein an arrangement which is provided in an open cavity of a shaping tool, e.g. of a compression mold, in a step a) comprises:
the ply of the shielding material,
a further ply serving to form the further layer, e.g. a reinforcing ply, and
a plastic arranged between these plies and serving to form the plastic layer, e.g. a plastic which is moldable by compression molding.

The term “plies” is used in connection with the arrangement, since at the moment when the arrangement is provided, in the open cavity of the shaping tool, the plies comprised of the arrangement need not yet be connected to one another, i.e. a layered assembly need not yet be present.

The shielding material is of course a precursor of the shielding layer. The shielding layer is therefore formed of the shielding material. The ply of the shielding material may therefore have a composition as described herein for the shielding layer.

The reinforcing ply is a precursor of the reinforcing layer. The reinforcing ply may in particular have a composition as described herein for the reinforcing layer.

The plastic forms a precursor of the plastic layer. The plastic may in particular have a composition as described herein for the plastic layer.

In a step b) downstream of the arrangement in the open cavity of the shaping tool, the shape of the protective element is at least partially defined by closing the shaping tool, by building up an elevated pressure and/or by supplying heat. Here, the shielding material is at least partially reshaped. For that purpose, the elevated pressure and/or the supply of heat are preferably regulated such that the plastic at least partially melts and a layered assembly is formed which comprises:
a shielding layer,
a further layer, e.g. a reinforcing layer, and
a plastic layer arranged between these layers.

In a step c) downstream of the at least partial definition of the shape of the protective element, the shaping tool is opened and the protective element or a protective element precursor is removed from the open cavity of the shaping tool.

The protective element precursor may differ from the protective element in that, for example
it does not comprise a contacting zone; and/or
it comprises fewer layers than the protective element.

After the removal of the protective element precursor from the open cavity of the shaping tool, the protective element precursor may be converted into the protective element by means of at least one subsequent machining step.

A subsequent machining step may comprise the formation of the contacting zone.

The contacting zone may be formed by introduction of a passage opening, with the passage opening extending preferably through the shielding layer.

A subsequent machining step may comprise the attachment of a further layer on the protective element precursor.

The contacting zone may be formed in the shaping tool.

The arrangement may preferably further comprise a capping ply on a side, facing away from the plastic, of the ply of the shielding material, wherein the shielding material in the arrangement, in an overhang portion of the arrangement, projects beyond the edge of the capping ply, wherein the action of the elevated pressure and/or the action of the heat produce a displacement force which displaces the shielding material in the overhang portion, to form an offset zone, wherein after the shaping, the shielding material extends in a different direction in the offset zone than in the overhang portion.

The capping ply may be, for example, the high-temperature thermal insulation layer or a precursor of the high-temperature thermal insulation layer.

The capping ply may preferably contain a hot-gas barrier. The hot-gas barrier may preferably contain a mineral barrier material. The features, indicated in this connection and described in more detail above in connection with the high-temperature thermal insulation layer, may also be features of the capping ply described in connection with the shaping method.

It may be particularly advantageous if the arrangement on both sides of the plastic comprises respectively at least one reinforcing ply. It is possible accordingly, in a particularly simple way, to obtain a protective sandwich element which is highly mechanically robust and has a reinforcing layer on both sides of the plastic layer.

The method may comprise an injection molding method, wherein the ply of the shielding material is positioned between two mold halves of an injection mold in a step a).

The ply of the shielding material may be interpreted as a precursor of the shielding layer described herein. The features described in connection with the shielding layer may also be features of the shielding material.

Particularly in connection with the shaping method, e.g. injection molding method, it may be particularly advantageous if the ply of the shielding material is a closed-surface ply. A closed-surface ply refers to a ply which has no passage openings through which, for instance, a fluid could flow through the shielding material, from one surface of the shielding material to the other surface of the shielding material.

It may be particularly advantageous if the ply of the shielding material is an aluminum foil or an aluminum sheet, wherein the thickness of the ply is preferably 0.02 to 1 mm, e.g. 0.03 to 0.3 mm.

In a step b) downstream of the positioning of the ply of the shielding material between the mold halves of the injection mold, a shape of the shielding material, desired for the protective element, is defined in the injection mold by reshaping. The shape of the shielding material may be defined in the injection mold by at least partially closing the injection mold. The injection mold may therefore in particular be an integrated injection mold and shaping tool.

In a step c) downstream of the defining of the desired shape of the shielding material, a plastic layer, e.g. a layer of melted plastic, is applied on at least one of the two surfaces of the shielding material. Features described herein in connection with the plastic layer may be features of the plastic layer applied in this step.

It may be preferable if in an optional step d) a plastic layer, e.g. a layer of melted plastic, is also applied on the other of the two surfaces of the shielding material. The features described herein in connection with the plastic layer may be features of the plastic layer applied in this step.

It may be particularly advantageous if in the plastic, e.g. in the plastic which is applied on one of the two surfaces of the shielding material, or in the plastic which is applied on both surfaces of the shielding material, there are fibers dispersed, wherein a mean length of the fibers may be preferably 1 mm to 40 mm, e.g. 2 mm to 20 mm.

The fibers may be selected from glass fibers, carbon fibers and polymer fibers.

The method for producing the protective element may be a combined compression molding and injection molding method.

The method may be a method for producing a protective element, comprising an electrically conductive discharge element integrated into the protective element, wherein the electrically conductive discharge element is in electrically conductive contact with the contacting zone.

It may be preferable to produce the electrically conductive contact of the discharge element with the contacting zone on the very ply of the shielding material that is introduced into the method for producing the protective element. The discharge element may be integrated into the protective element, for example, by attaching the discharge element on the shielding material through a layer which is formed in the course of the method, for example through the plastic layer, through the electrically insulating protective layer or through the high-temperature thermal insulation layer. The discharge element may be a sleeve which is at least partially surrounded by the layer formed in the course of the method.

The protective element is preferably a protective element having a concave inside and a convex outside.

The protective element may be, for example, an underbody protection element. The underbody protection element may be a battery casing floor element intended for arrangement beneath a battery of a motor vehicle.

The protective element may be a casing element. The casing element may preferably be a casing cover, a casing wall or a casing tray.

The protective element may preferably be a battery casing element. The battery casing element may preferably be a battery casing cover, a battery casing wall or a battery casing tray.

The protective element may be a battery casing element for arrangement between the battery and an electrical unit, e.g. an electrical communication unit, of a motor vehicle.

Further preferred features and/or advantages of the invention are the subject matter of the description below and of the drawings representing exemplary embodiments.

### BRIEF DESCRIPTION OF THE DRAWINGS

FIG. 1 shows a schematic sectional representation of a detail of a protective element;

FIG. 2 shows a schematic sectional representation of a detail of a protective element;

FIG. 3 shows a schematic sectional representation of a detail of a protective element;

FIG. 4 shows an enlarged detail from FIG. 3;

FIG. 5 shows section B-B from FIG. 3;

FIG. 6 shows a schematic sectional representation of a detail of a protective element, the element being arranged on a mass of a motor vehicle;

FIG. 7 shows section A-A from FIG. 6;

FIG. 8 shows section B-B from FIG. 6;

FIG. 9 shows a schematic sectional representation of a detail of a protective element, the element being arranged on a mass of a motor vehicle;

FIG. 10 shows a schematic sectional representation of a detail of a protective element, the element being arranged on a mass of a motor vehicle;

FIG. 11 shows a schematic sectional representation of a detail of a protective element, the element being arranged on a mass of a motor vehicle;

FIG. 12 shows a schematic sectional representation of a detail of a protective element, the element being arranged on a mass of a motor vehicle;

FIG. 13 shows a schematic sectional representation of a detail of a protective element, the element being arranged on a mass of a motor vehicle;

FIG. 14 shows a schematic sectional representation of a detail of a protective element, the element being arranged on a mass of a motor vehicle;

FIG. 15 shows a schematic sectional representation of a detail of a protective element, the element being arranged on a mass of a motor vehicle;

FIG. 16 shows a discharge element;

FIG. 17 shows a schematic sectional representation of a detail of a protective element, the element being arranged on a mass of a motor vehicle;

FIG. 18 shows a schematic representation of a shaping method;

FIGS. 19-26 show illustrative details from FIG. 18 for different layer structures of the resultant protective element;

FIG. 27 shows an edge portion of a protective element obtainable by the method according to FIG. 18;

FIG. 28 shows section A-A from FIG. 27;

FIG. 29 shows section B-B from FIG. 27;

FIG. 30 shows an illustrative detail from FIG. 18 with a securement arrangement in an overhang portion;

FIG. 31 shows a schematic representation of the resultant edge portion of a protective element in the context of an overhang portion according to FIG. 30;

FIG. 32 shows an edge portion of a protective element, obtainable according to FIGS. 30 and 31;

FIG. 33 shows section A-A through FIG. 32 with an additionally represented mass;

FIG. 34 shows section C-C through FIG. 32 with an additionally represented mass;

FIG. 35 shows a schematic sectional representation of a shaping tool;

FIG. 36 shows a shaping tool according to FIG. 35 with arranged shielding material;

FIG. 37 shows a shaping tool according to FIG. 35 with positioned shielding material;

FIG. 38 shows a shaping tool according to FIG. 35 with reshaped shielding material;

FIG. 39 shows a shaping tool according to FIG. 35 after application of a first plastic layer;

FIG. 40 shows a shaping tool according to FIG. 35 after application of a second plastic layer;

FIG. 41 shows a shaping tool according to FIG. 40 in a compressed state;

FIG. 42 shows a shaping tool according to FIG. 41 after a punching step;

FIG. 43 shows an opened shaping tool according to FIG. 35 with a protective element;

FIG. 44 shows a schematic sectional representation of a protective element, arranged on a mass, with shielding deflection zone, concave zone and convex counterzone;

FIG. 45 shows a shielding layer in the assembly with a plastic layer;

FIG. 46 shows a schematic sectional representation of a detail of a protective element, arranged on a mass, with shielding deflection zone;

FIG. 47 shows a shielding layer in the layered assembly with a plastic layer;

FIG. 48 shows a possibility for incorporating a contacting element in a method for producing a protective element;

FIG. 49 shows a schematic representation of a detail of a protective element obtained according to the method of FIG. 48;

FIG. 50 shows a possibility for incorporating a contacting element in a further method for producing a protective element;

FIG. 51 shows a schematic representation of a detail of a protective element obtained according to the method of FIG. 50;

FIG. 52 shows a possibility for incorporating a contacting element in a further method for producing a protective element;

FIG. 53 shows a possibility for incorporating a contacting element in a further method for producing a protective element;

FIG. 54 shows a schematic representation of a detail of a protective element obtained according to the method of FIG. 53;

FIG. 55 shows a possibility for incorporating a contacting element in a further method for producing a protective element;

FIG. 56 shows a schematic representation of a detail of a protective element obtained according to the method of FIG. 55;

FIG. 57 shows a possibility for incorporating a contacting element in a further method for producing a protective element;

FIG. 58 shows a schematic representation of a detail of a protective element obtained according to the method of FIG. 57;

FIGS. 59-60 show a possibility for incorporating two contacting elements in a further method for producing a protective element;

FIG. 61 shows a schematic representation of a detail of a protective element obtained according to the method of FIGS. 59-60;

FIGS. 62-63 show a possibility for incorporating two contacting elements in a further method for producing a protective element;

FIG. 64 shows a schematic representation of a detail of a protective element obtained according to the method of FIGS. 62-63;

FIGS. 65-66 show a possibility for incorporating a contacting element and a sleeve in a further method for producing a protective element;

FIG. 67 shows a schematic representation of a detail of a protective element obtained according to the method of FIGS. 65-66;

FIG. 68-69 show a possibility for incorporating two contacting elements in a further method for producing a protective element;

FIG. 70 shows a schematic representation of a detail of a protective element obtained according to the method of FIGS. 68-69;

FIGS. 71-72 show a possibility for incorporating a contacting element in a further method for producing a protective element;

FIG. 73 shows a schematic representation of a detail of a protective element obtained according to the method of FIGS. 71-72;

FIGS. 74-75 show a possibility for incorporating a contacting element in a further method for producing a protective element;

FIG. 76 shows a schematic representation of a detail of a protective element obtained according to the method of FIGS. 74-75;

FIG. 77 shows a possibility for incorporating a contacting element in a further method for producing a protective element;

FIG. 78 shows a schematic representation of a detail of a protective element obtained according to the method of FIG. 77;

FIGS. 79-80 show a possibility for incorporating a contacting element in a further method for producing a protective element;

FIG. 81 shows a schematic representation of a detail of a protective element obtained according to the method of FIGS. 79-80;

FIG. 82 shows a schematic representation of a mold half with punch element;

FIG. 83 shows the schematic representation from FIG. 82 with contacting element;

FIG. 84 shows the schematic representation from FIG. 82 with contacting element;

FIG. 85 shows a schematic representation of a mold half with punch element and shielding material;

FIG. 86 shows a schematic representation of a mold half with punch element, shielding material and counterhold elements;

FIG. 87 shows the representation from FIG. 86 after production of a passage opening;

FIG. 88 shows the representation from FIG. 87 with finally reshaped shielding layer overhang;

FIGS. 89-91 show a possibility, building on the representations in FIGS. 82-88, for integrating a contacting element in a further method for producing a protective element;

FIGS. 92-93 show a further possibility, building on the representations in FIGS. 82-88, for integrating a contacting element in a further method for producing a protective element;

FIG. 94 shows a greatly simplified perspective representation of a protective element; and

FIG. 95 shows a section through the protective element from FIG. 94 with additional details.

### DETAILED DESCRIPTION OF THE DRAWINGS

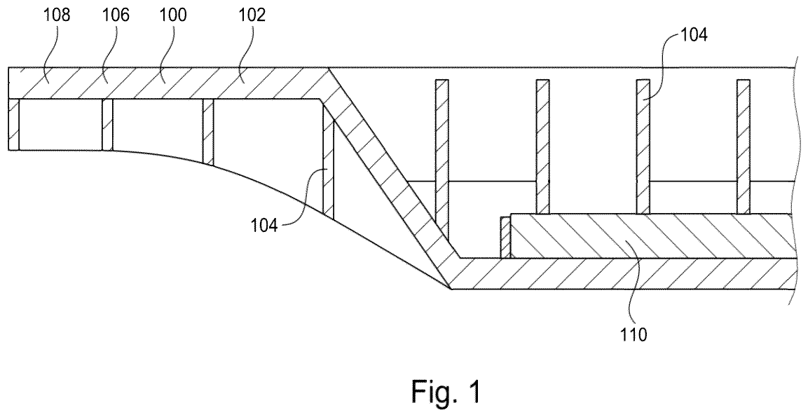

FIG. 1 shows a protective element 102 embodied as an aluminum component 100. The protective element 102 comprises reinforcing ribs 104 which likewise consist of aluminum. The protective element 102 shown may be installed as a battery casing part 106. In that case it may function in particular as an underbody protection element 108.

The protective element 102 comprises an insulation layer 110, which may consist, for example, of a foam material.

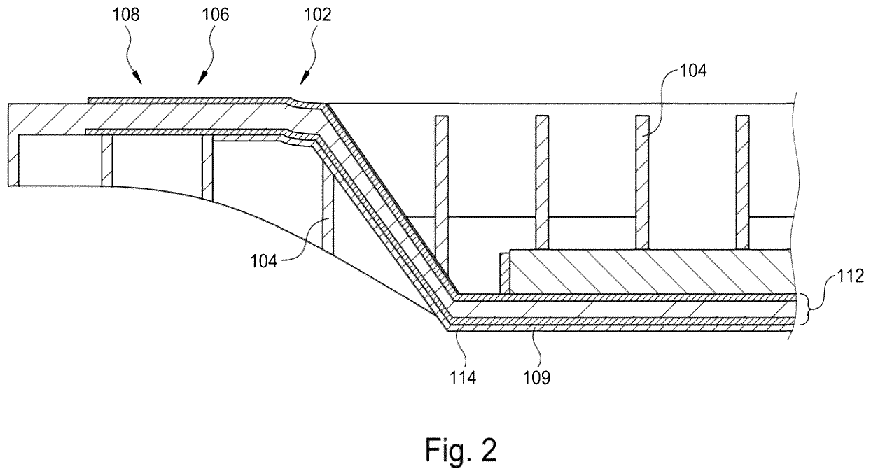

The protective element shown in FIG. 2 differs from the protective element shown in FIG. 1 in that it is not embodied as an aluminum component 100, instead comprising a separate shielding component 109 and a further casing component 112, with the shielding component 109 and the casing component 112 being separately fabricated and subsequently joined. The shielding component 109 may be fabricated, for example, from aluminum and may form a shielding layer 114, which is able very largely to shield from electromagnetic radiation.

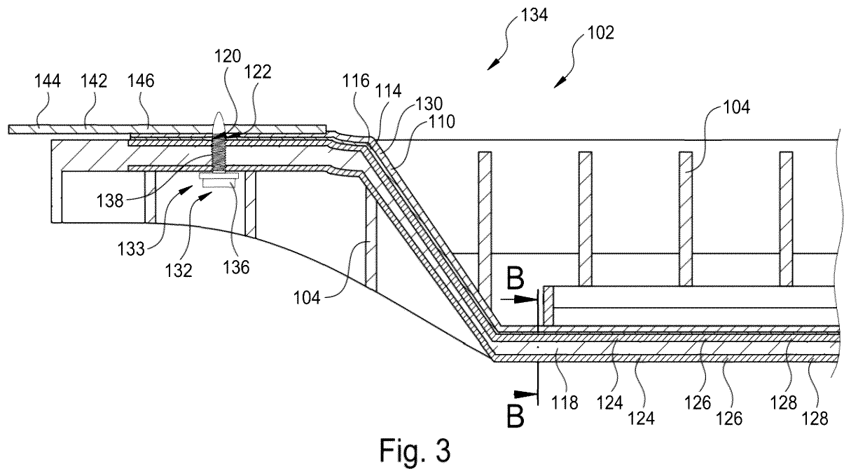

FIG. 3 shows a protective element 102. The protective element 102 comprises a shielding layer 114. The shielding layer 114 is an aluminum foil 116. The protective element 102 comprises a plastic layer 118. The plastic layer 118 completely covers the shielding layer 114.

The protective element 102 shown in FIG. 3 comprises a contacting zone 120. The contacting zone 120 is configured on a shielding layer end face. The shielding layer end face is an inner-surface contacting zone 122 encircling a passage opening. Electrical contact between the shielding layer 114 and a device on which the protective element may be arranged can be produced by means of the inner-surface contacting zone 122.

The protective element 102 shown in FIG. 3 comprises reinforcing layers 124. These are reinforcing layers 124 reinforced with fibers 126. The reinforcing layers 124 reinforced with fibers 126 are organic sheets 128.

The protective element shown in FIG. 3 comprises a protective layer 130. The protective layer 130 is an insulation layer 110. The insulation layer 110 may be electrically insulating and be an electrically insulating protective layer. Alternatively or additionally, the insulation layer may be a high-temperature thermal insulation layer.

Together with the contacting element 132, the protective element 102 forms a component set 134.

The contacting element 132 is a connecting element 133. The contacting element 132 is in electrically conductive contact with the contacting zone 120. The contacting element 132 is a screw 136. The screw 136 comprises a thread 138.

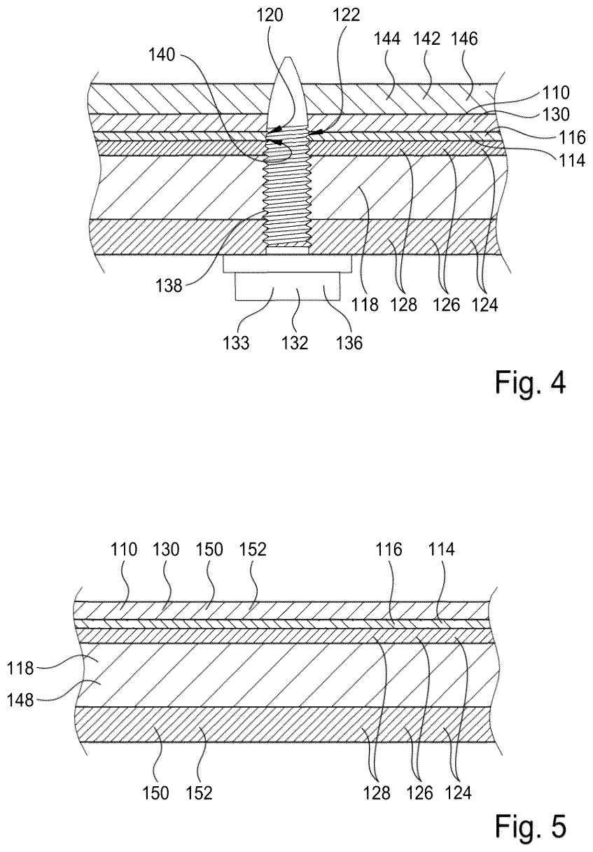

FIG. 4 shows a detail from FIG. 3 in enlarged representation. The contacting zone 120 is an inner-surface contacting zone 122 formed on the encircling shielding layer end face 140.

The mass 142 shown in FIG. 4 forms a part of the device which emits electromagnetic radiation. In the case of a motor vehicle and also in the case of motorcycles and pedal cycles, the mass potential is the bodywork or the frame, respectively. The term “mass” refers to this mass potential. In FIG. 4, the mass 142 is a frame 146 which belongs to a carrier structure 144. There is electrical contact between the shielding layer 114 and the frame 146 comprised by the device, by way of the contacting element 132.

FIG. 5 shows section B-B from FIG. 3. The plastic layer 118 is a plastic core 148 which is arranged between reinforcing layers 124. One of the reinforcing layers 124 forms a capping ply 150. In the layered assembly, the capping ply 150 forms a capping layer 152. The shielding layer 114 is arranged between the other reinforcing layer 124 and the insulation layer 110, which forms a protective layer 130. The insulation layer 110 represents a further capping ply 150, which in the layered assembly forms a further capping layer 152.

A capping layer herein refers to the layers which conclude in the layer structure of the layered assembly.

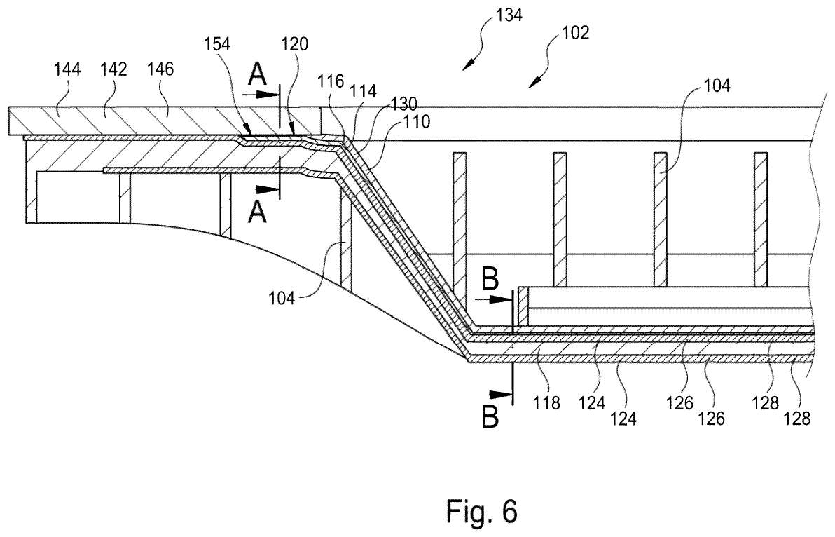

FIG. 6 shows a protective element 102, comprising a contacting zone 120, wherein the contacting zone 120 is an outer-surface contacting zone 154.

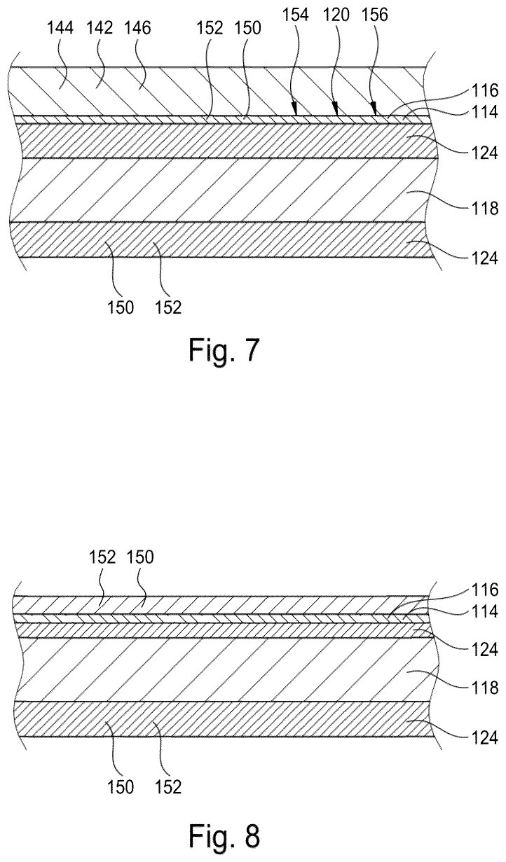

FIG. 7 shows section A-A from FIG. 6. An outer surface 156 of the shielding layer 114 forms the outer-surface contacting zone 154.

In the region of the protective element 102 shown by section A-A, the shielding layer 114 is wholly on the outside in the layer structure. It forms a capping layer 152. The outer-surface contacting zone 154 is in direct electrical contact with the mass 142. By means of the outer-surface contacting zone 154, therefore, it is possible to produce electrical contact between the shielding layer 114 and the device which comprises the mass 142.

FIG. 8 shows section B-B from FIG. 6. The layer structure shown in FIG. 8 corresponds to the layer structure shown in FIG. 5, as the protective elements from FIGS. 3 and 6 at the section point B-B have identical construction.

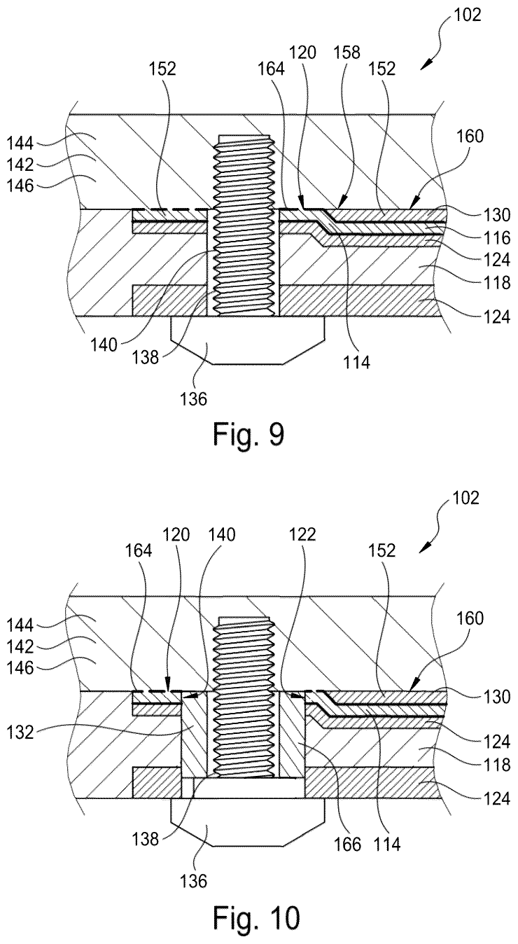

FIG. 9 shows a detail of a protective element 102 in the region of the contacting zone 120. The protective element comprises an offset zone 158. The shielding layer 114 extends in a different direction in the offset zone 158 than in the contacting zone 120. In the contacting zone 120, the shielding layer 114 forms a capping layer 152 of the protective element 102. In an insulation zone 160, which is separated from the contacting zone 120 by the offset zone 158, an electrically insulating protective layer 130 forms the capping layer 152.

The plastic layer 118 is thicker in a portion of the plastic layer 118 that overlaps with the contacting zone 120 than in a portion of the plastic layer 118 that overlaps with the insulation zone 160. An adhesion promoter 164 is arranged on each of the surfaces of the shielding layer 114. The contacting zone 120 is present at locations where the adhesion promoter 164 exhibits interruptions.

FIG. 9 as well shows a shielding layer end face 140. There, however, the shielding layer end face 140 does not form an inner-surface contacting zone encircling a passage opening, as the thread 138 of the screw 136 is at a distance from the shielding layer end face 140.

FIG. 10 shows a detail of a protective element 102 similar to the protective element 102 shown in FIG. 9. The shielding layer end face 140 forms an inner-surface contacting zone 122. Sleeve 166 forms a contacting element. There is electrical contact between the inner-surface contacting zone 122 and the contacting element 168. There is also electrical contact by the sleeve 166 with the mass 142. This electrical contact is promoted by the sleeve 166 being pressed by the screw 136 onto the mass 142.

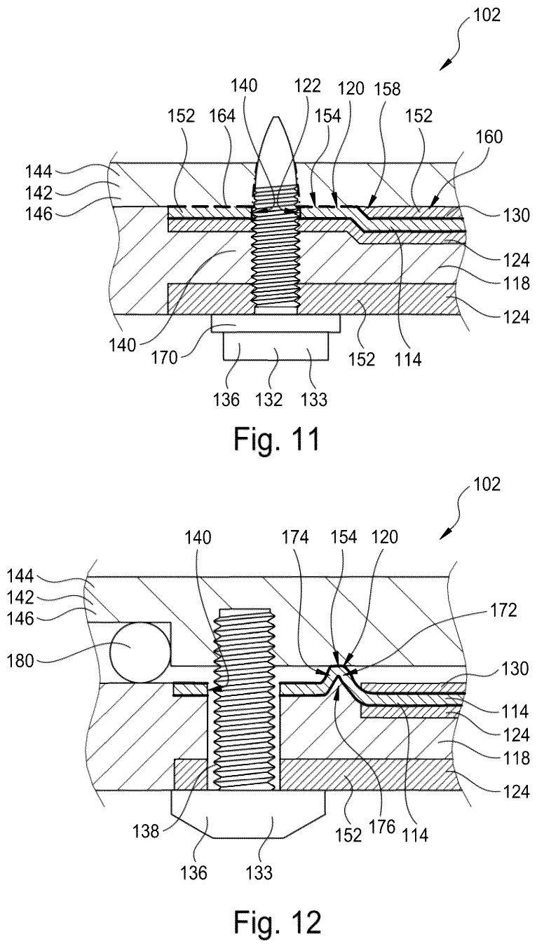

FIG. 11 shows a detail of a protective element. The protective element shown therein comprises an offset zone 158 and an insulation zone 160. The protective element 102 additionally comprises contacting zones 120. The contacting zones 120 comprise an outer-surface contacting zone 154 and an inner-surface contacting zone 122. Electrical contact between the shielding layer 114 and the mass 142 comprised by the device is produced by means of these contacting zones. There is direct electrical contact of the outer-surface contacting zone 154 with the mass 142 and there is also contact mediated by the contacting element 132 between the inner-surface contacting zone 122 and the mass 142 comprised by the device. The contacting element is a connecting element 133 embodied as a screw 136. The screw 136 is a flow-hole screw 170.

FIG. 12 shows a detail of a protective element 102. The protective element 102 comprises a protrusion zone 172. The protrusion zone 172 protrudes from a surface of the protective element 102 and defines the contacting zone 120. The contacting zone 120 is therefore an outer-surface contacting zone 154.

In the protrusion zone 172, the shielding layer 114 protrudes from the surface of the protective element 102. In the protrusion zone 172, the shielding layer 114 comprises a protrusion element 174. The protrusion element 174 is a bead 176, with the bead 176 protruding from the surface of the protective element. Thread 138 engages in a counterthread present in the mass 142, and so the outer-surface contacting zone 154 defined by the protrusion zone 172 is pressed onto the surface of the mass 142. In this process, the sealing element 180 arranged in the recess 178 is also compressed. The shielding layer end face 140 at a distance from the thread 138 does not form an inner-surface contacting zone.

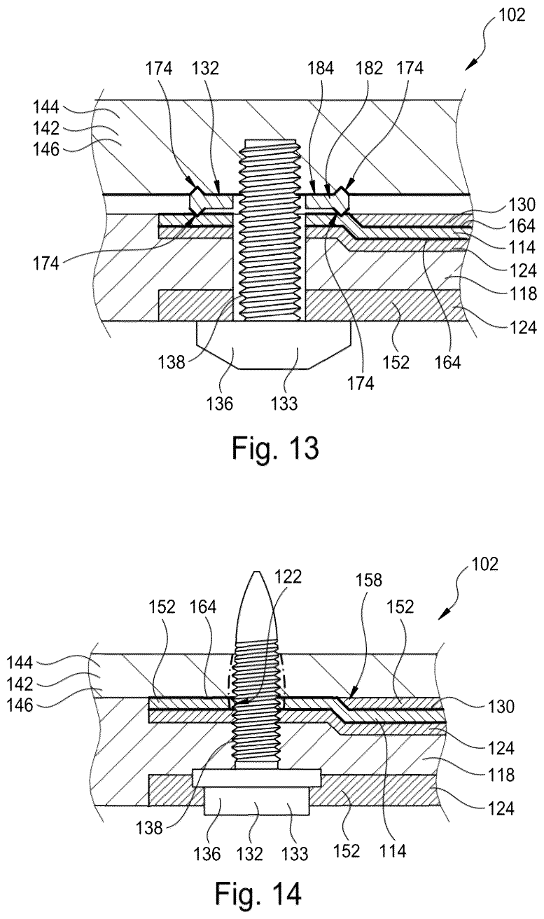

FIG. 13 shows a portion of a protective element 102. The contacting element 132 is a washer 182. The contacting element 132 comprises protrusion elements 174 facing the shielding layer 114. The contacting element 132 comprises protrusion elements 174 facing away from the shielding layer 114.

The protrusion elements 174 mediate electrically conductive contacts of an outer surface of the shielding layer 114 with the contacting element 132 and of the contacting element 132 with the mass 142 when the protective element 102 is pressed onto the mass by way of the thread 138 of the screw 136 and the corresponding counterthread in the mass 142. The protrusion elements 174 perforate the adhesion promoter 164, thereby mediating the electrically conductive contact of the shielding layer via the contacting element with the mass. The contacting element 132 in the form of the washer 182 functions as a bridging element 184.

FIG. 14 shows a detail of a protective element 102. An adhesion promoter 164 is arranged on each of the surfaces of the shielding layer. The protective element 102 therefore does not comprise an outer-surface contacting zone 154, but only an inner-surface contacting zone 122. By means of the inner-surface contacting zone 122, electrical contact is produced by the contacting element 132 between the shielding layer 114 and the mass 142 which is comprised by the device. The contacting element 132 is a connecting element 133. The connecting element 133 is a screw 136 with a thread 138.

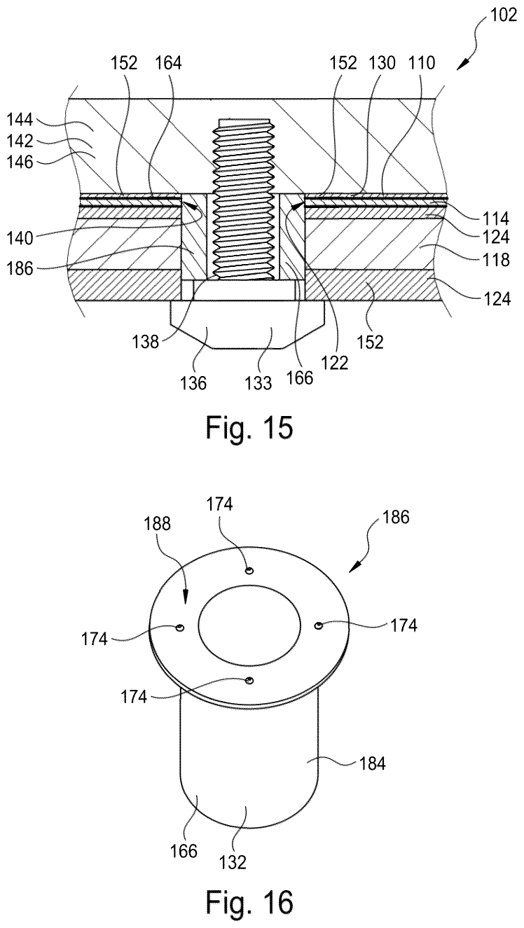

FIG. 15 shows a detail of a protective element 102. An inner-surface contacting zone 122 is configured on a shielding layer end face 140. The protective element 102 does not comprise an outer-surface contacting zone 154. An electrically insulating protective layer 130 completely covers the shielding layer 114. The protective layer 130 forms the capping layer 152, and so there is no direct electrical contact between a surface of the shielding layer 114 and the mass 142 comprised by the device. The shielding layer 114 is therefore concealed on the contacting zone by an electrically insulating capping layer 152.

The protective element 102 comprises an integrated electrically conductive discharge element 186 in the form of a sleeve 166. The electrically conductive discharge element 186, i.e. the sleeve 166, is in electrically conductive contact with the inner-surface contacting zone 122. The electrically conductive discharge element 186, i.e. the sleeve 166, extends through the electrically insulating capping layer 152.

FIG. 16 shows an electrically conductive discharge element 186. The discharge element 186 is a sleeve 166. The discharge element 186 comprises an end-face surface 188. The end-face surface comprises protrusion elements 174 which project from the end-face surface 188.

Depending on the way in which the discharge element 186 is integrated into the protective element 102, the discharge element 186 may serve as a contacting element 132, as a connecting element 133 and/or as a bridging element 184.

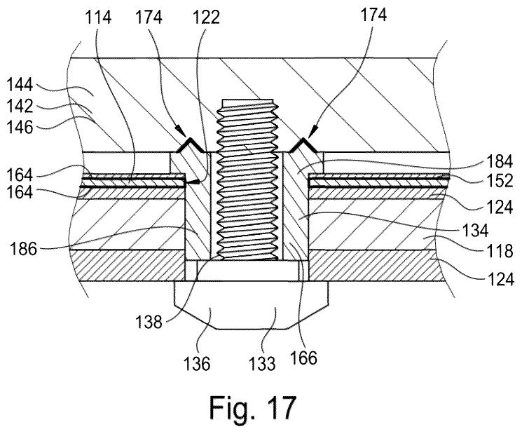

FIG. 17 shows a detail of a protective element 102. The protective element 102 comprises an integrated electrically conductive discharge element 186 according to FIG. 16. The electrically conductive discharge element 186 is in electrically conductive contact with the inner-surface contacting zone 122. The electrically conductive discharge element 186 is also in electrically conductive contact with the mass 142 comprised by the device. The electrically conductive contact with the mass 142 is mediated by the protrusion elements 174. Depending on the material of which the screw 136 is formed, there may be further electrically conductive contact by the inner-surface contacting zone 122 via the discharge element 186 and the screw 136 serving as connecting element 133. The protective element 102 shown in FIG. 17 does not comprise an outer-surface contacting zone 154, because an electrically insulating capping layer 152 completely covers the shielding layer.

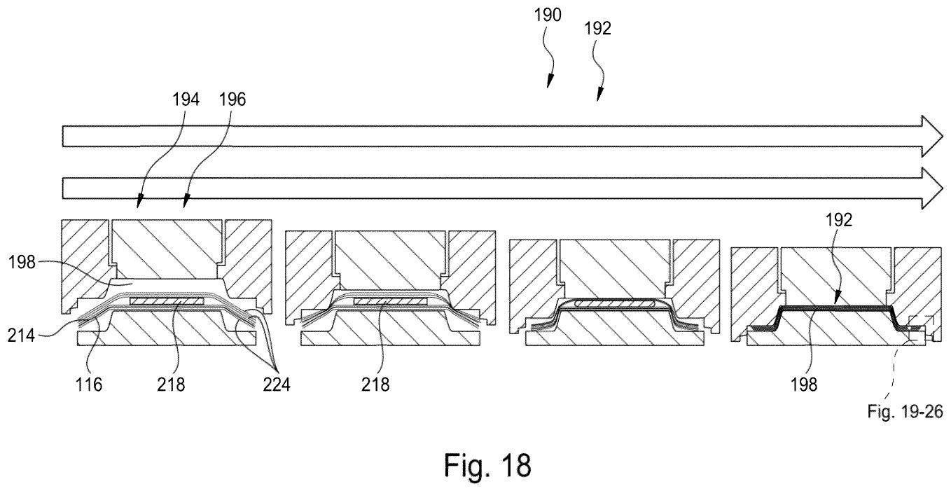

FIG. 18 illustrates a shaping method 190 of the invention. The shaping method 190 is a compression molding method 192.

FIG. 18 shows four different states which are traversed in the course of the compression molding method. The four states are each distinguished by a defined degree of reshaping and by a defined degree of mold filling. From left to right, the degree of reshaping, which increases in the direction of the arrow, is around 10%, around 20%, around 80%, and 100%. From left to right, the degree of mold filling, which increases in the direction of the arrow, is around 30%, around 30%, around 40%, and 100%.

In the state represented on the very left, the shaping tool 194 is open. The shaping tool 194 is a compression mold 196. Provided in the open cavity 198 of the shaping tool 194 is an arrangement comprising the following: a ply of a shielding material 214, a plurality of reinforcing plies 224, and a plastic 218 arranged between at least two of the reinforcing plies. The shape of the protective element is defined at least partially by closing the shaping tool 194, by building up an elevated pressure and/or by supplying heat. In this case, the shaping tool 194 passes through the four states represented in FIG. 18.

In the state represented on the very right, the shape of the protective element 102 is defined nearly completely or completely and the cavity 198 is substantially completely closed.

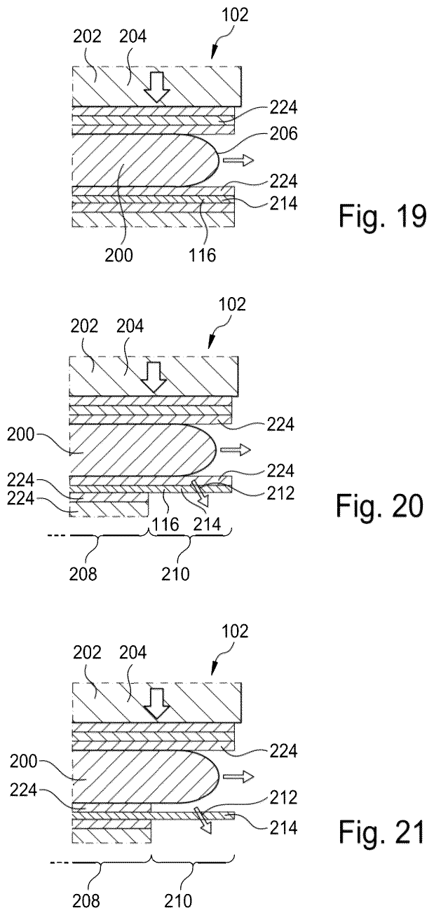

Depending on the nature of the arrangement and particularly of the edge region of the arrangement, the protective element 102 may adopt very different structures on the contacting zone, these structures being described more closely in the subsequent FIGS. 19 to 26.

FIG. 19 shows an edge portion of a resulting protective element 102. FIG. 19 shows three respective reinforcing plies 224 on the two surfaces of the plastic melt 200 arising from the plastic 218. The shielding material 214, which is an aluminum foil 116, is arranged between two of the reinforcing plies 224. The shaping element 202 is a compression molding element 204 and forms a constituent of the shaping tool 194, which is a compression mold 196.

The arrow pointing vertically downward and drawn in on the shaping element 202 in FIG. 19 indicates a pressure which acts on the arrangement of plies represented. The effect of the pressure is to move the front 206 of the plastic melt 200 and to fill the space between the reinforcing plies.

FIG. 20 shows an edge portion of a further resultant protective element 102. The resultant protective element 102 comprises an overlap portion 208 and an overhang portion 210. In the overhang portion 210, the shielding material 214, i.e. the aluminum foil 116, and a part of the reinforcing plies 224 extend beyond another part of the reinforcing plies 224. The pressure built up by the compression molding element 204 produces an offsetting force 212. The effect of the offsetting force 212 is to bend the shielding material 214 in the overhang portion. The bending is not represented in FIG. 20. As a result, the development of an offset zone 158 may be produced in the compression molding step, such a zone being shown in FIG. 11, for example. In the protective element 102 obtained on conclusion of the compression molding step, the shielding layer 114, which originates from the shielding material 214, has an outer-surface contacting zone 154 in the overhang portion 210. This is because in the overhang portion 210, the shielding layer 114 forms a capping layer 152.

FIG. 21 shows an arrangement in which a reinforcing ply 224 arranged between shielding material 214 and the plastic melt 200 does not extend into the overhang portion 210. The plastic melt 200 is therefore able to make direct contact with the shielding material 214 and produce the bending of the shielding material described in connection with FIG. 20.

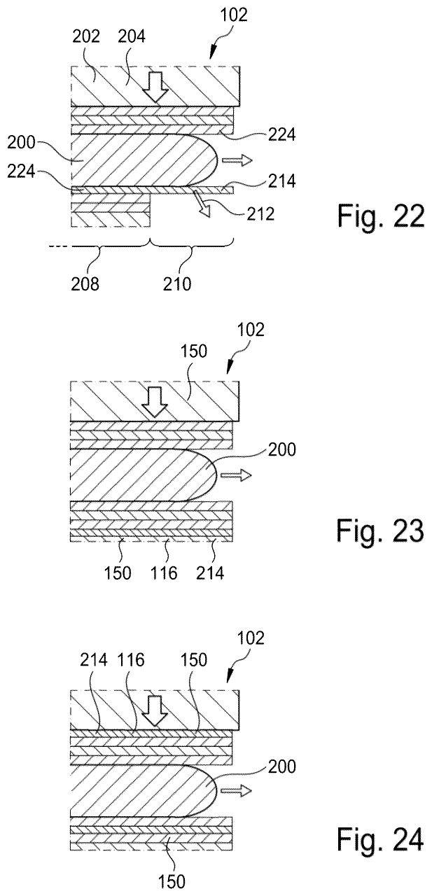

In the case of the arrangement shown in FIG. 22, the shielding material 214 is arranged between the plastic melt 200 and a reinforcing ply 224. In contrast to the arrangements shown in FIGS. 20 and 21, there is no reinforcing ply between the plastic melt 200 and the shielding material 214.

The arrangement shown in FIG. 23 corresponds to the arrangement shown in FIG. 19. In contrast to FIG. 19, the shielding material 214, i.e. the aluminum foil 116, is arranged on the very outside in the ply structure of the arrangement. The shielding material 214 forms a capping ply 150. In the fully produced protective element 102, therefore, there may be an outer-surface contacting zone 154, without any need for an offsetting force described in connection with FIGS. 20 to 22 to bend the shielding material 214.

The arrangement shown in FIG. 24 corresponds to the arrangement from FIG. 23. In contrast to the arrangement in FIG. 23, the shielding material 214, i.e. the aluminum foil 116, is arranged on the other side of the arrangement in the ply structure.

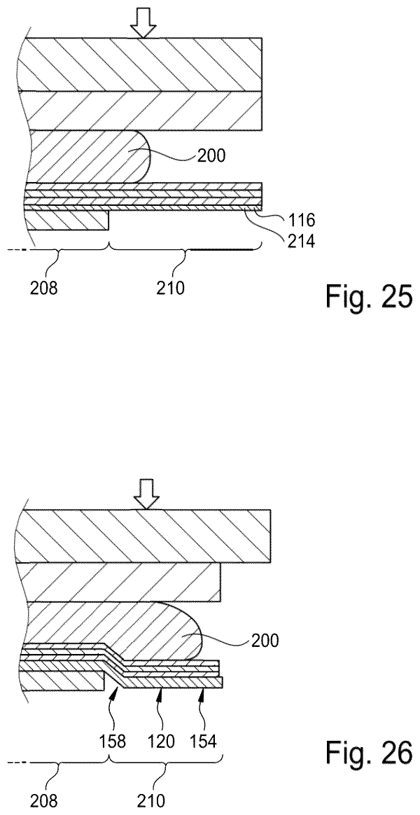

FIGS. 25 and 26 illustrate the state respectively before and after the bending of the shielding material 214 as a result of the offsetting force 212. Clearly apparent in FIG. 26 is an offset zone 158 which has come about, as a consequence of the bending, at the transition between overhang portion 210 and overlap portion 208.

FIG. 26 as well shows the contacting zone 120 which is formed in the completed protective element 102 and is an outer-surface contacting zone 154.

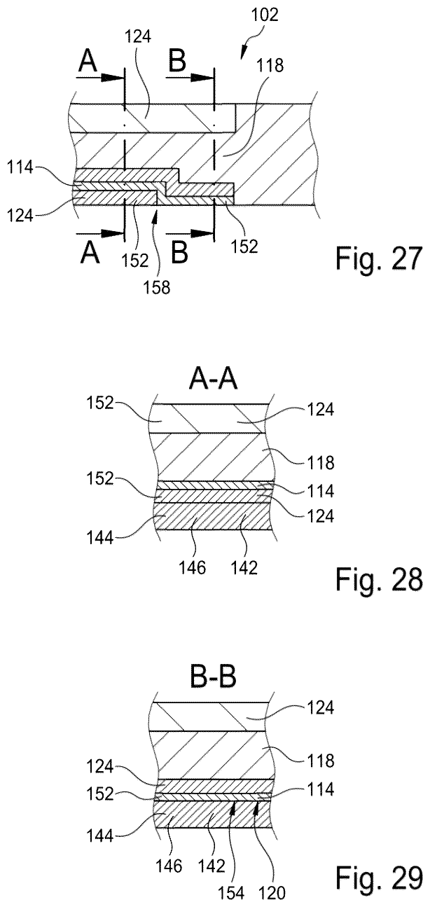

On conclusion of the compression molding illustrated in FIGS. 25 and 26, a protective element 102 may be produced, the edge of which is shown in FIG. 27. In the example shown therein, the shielding layer 114 has two approximately right-angled bends in the region of the offset zone 158. On one side of the offset zone, the reinforcing layer 124 forms the capping layer 152. On the other side of the offset zone, the shielding layer 114 forms the capping layer 152.

FIG. 28 shows section A-A through the protective element 102 shown in FIG. 27. Additionally represented is the mass 142 comprised by the device. In this region, the reinforcing layer 124 forms the capping layer 152. The latter is arranged between the mass 142 and the shielding layer 114. There is consequently no contacting zone 120 there.

FIG. 29 shows section B-B through the protective element 102 shown in FIG. 27. The shielding layer 114 forms the capping layer 152. There is electrical contact between the shielding layer 114 and the mass 142 comprised by the device. The mass may be formed by a frame 146 of a carrier structure 144. In the region of the section B-B, therefore, the protective element comprises a contacting zone 120. The contacting zone is an outer-surface contacting zone 154.

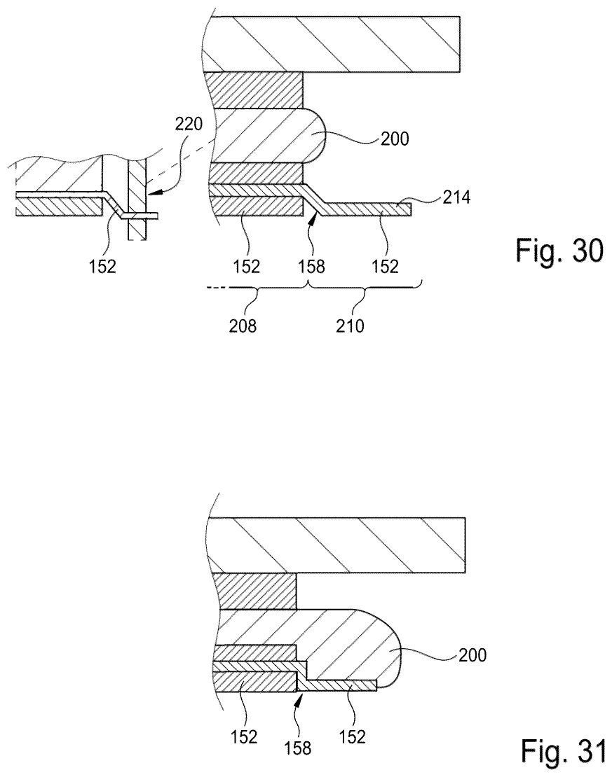

The arrangement shown in FIG. 30 corresponds to the arrangement shown in FIG. 25. In the case of the arrangement shown in FIG. 30, however, only the shielding material 214 extends into the overhang portion 210. In the example shown here, the offset zone 158 is a preformed offset zone 158, which is prelocated in the shielding material 214 which is introduced into the shaping tool 194.

Especially if only the shielding material 214 extends into the overhang portion 210, it may be advantageous to hold overhanging shielding material 214 in position with the aid of a securement arrangement 220 and to form bends characteristic of the offset zone in the shielding material 214. This is indicated in FIG. 30 in the section represented on the left.

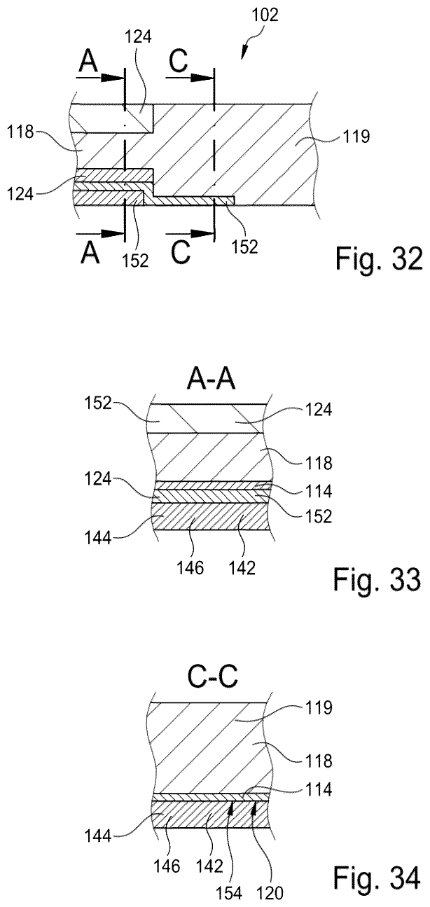

FIGS. 31 and 32 show that during compression molding, the plastic melt 200 enters the overhang portion 210.

FIG. 33 shows section A-A through the protective element 102 shown in FIG. 32, with the mass 142 being represented additionally. There, the reinforcing layer 124 forms the capping layer 152. There is no contacting zone 120 there, as the reinforcing layer is arranged between the shielding layer and the mass comprised by the device.

FIG. 34 shows section C-C through the protective element 102 represented in FIG. 32, with the mass 142 being represented additionally. There, there is electrical contact between the shielding layer 114 and the mass 142 comprised by the device. The protective element therefore comprises a contacting zone 120. The contacting zone 120 is an outer-surface contacting zone 154. In the region of the contacting zone 120, the protective element 102 does not comprise a reinforcing layer 124; other than the shielding layer 114, the layer structure contains only the plastic layer 118.

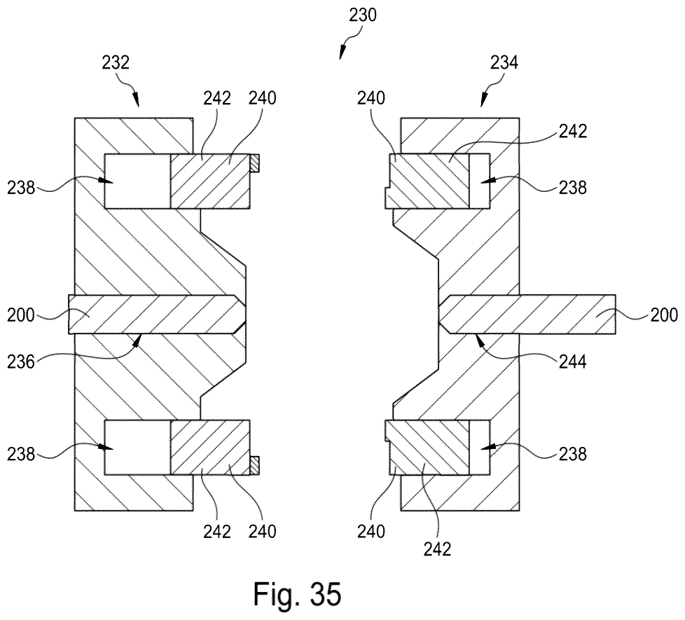

FIGS. 35 to 43 illustrate a shaping method for producing a protective element 102. The shaping method is an injection molding method.

The injection molding method takes place in an injection mold 230. The injection mold 230 comprises a first mold half 232 and a second mold half 234.

The first mold half 232 comprises a first feed zone 236 for the supply of a plastic melt 200. The first mold half 232 comprises guiding zones 238. In the guiding zones 238, retaining elements 240 are guided. The retaining elements 240 can be used for punching. These are punching elements 242.

The second mold half comprises a second feed zone 244. The second mold half comprises retaining elements 240 guided in guiding zones 238. The retaining elements 240 can be used for punching. These are punching elements 242.

FIG. 35 shows the injection mold in an opened state with open cavity 198.

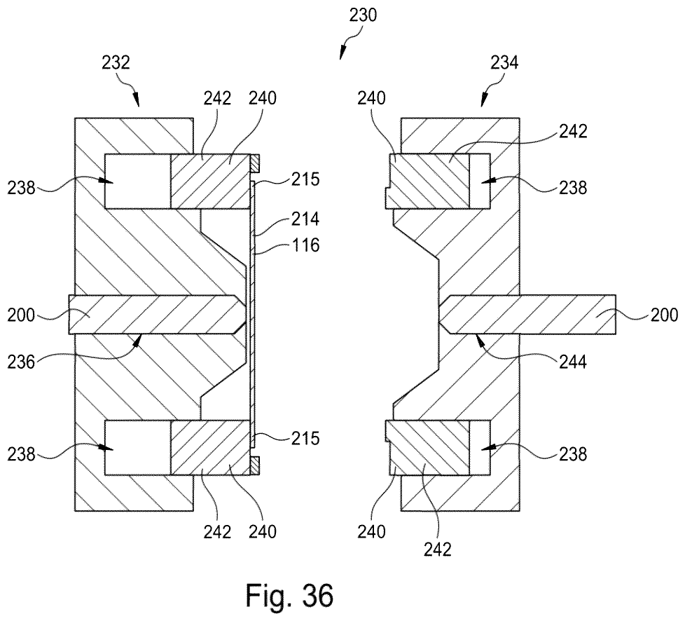

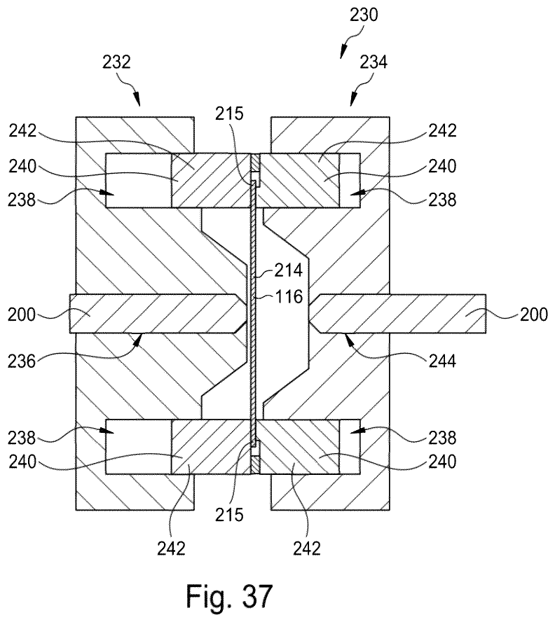

FIG. 36 shows the positioning of a ply of a shielding material 214 between the mold halves 232 and 234. For positioning the shielding material 214 between the mold halves 232 and 234, the injection mold 230 can be partially closed and/or retaining elements 240 guided in the guiding zones 238 can be moved toward one another. In particular, a respective retaining element 240 of a mold half 232, 234 may lie against edges 215 of the shielding material such that the shielding material 214 is held in a desired position by the retaining elements 240. This is shown in FIG. 37.

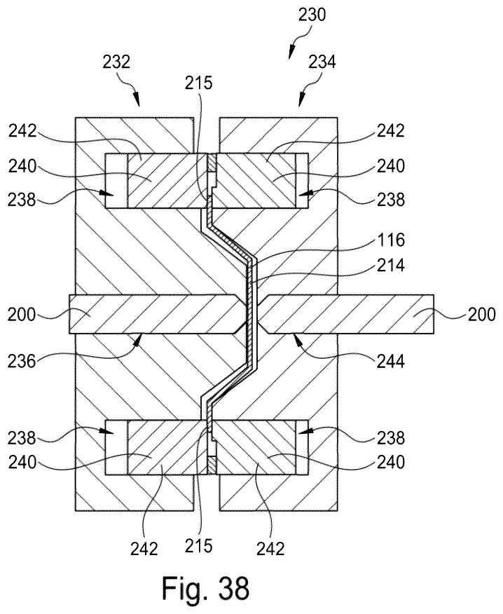

By further closing of the injection mold 230, the shielding material can be reshaped and hence a shape of the shielding material 214 that is desired for the protective element 102 can be defined in the injection mold 230. FIG. 38 shows the injection mold 230 and the shielding material 214 which is located therein and has been brought to the desired shape.

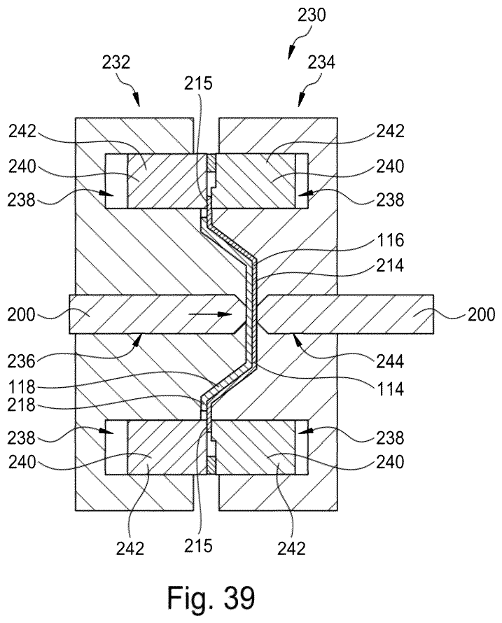

A plastic layer 118 may be applied to one of the two surfaces of the shielding material 214. For this purpose, the plastic melt 200 may be conveyed from the first feed zone 236 into a gap which exists between one of the surfaces of the shielding material 214 and a surface of the first mold half 232. In the largely closed injection mold 230, the retaining elements 240 and the reshaped shielding material held by the retaining elements may be moved toward the second mold half 234 for this purpose. Accordingly, the width of the gap and hence ultimately the thickness of the plastic layer 118 to be applied can be controlled. The processing state attained after the application of the plastic layer 118 is represented in FIG. 39.

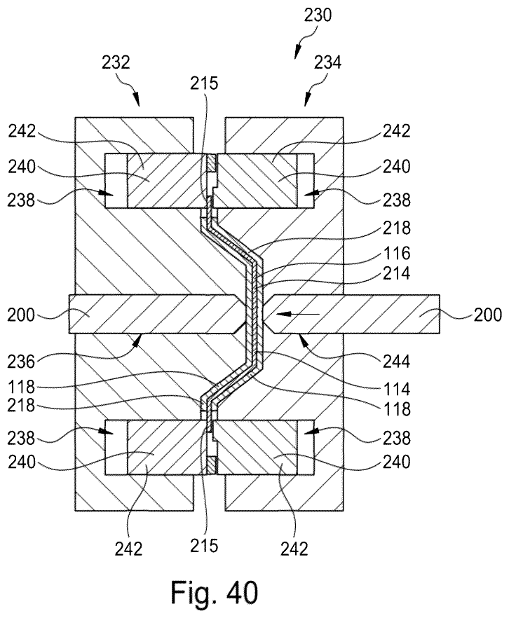

The injection mold may be easily opened by modification to the position of the second mold half 234, producing a gap between the surface of the second mold half 234 and the shielding layer 114. Plastic melt 200 may be passed through the second feed zone 244 into the gap, so that a plastic layer 118 is also applied to the other of the two surfaces of the shielding material 214. In this case, the fabrication state represented in FIG. 40 is attained.

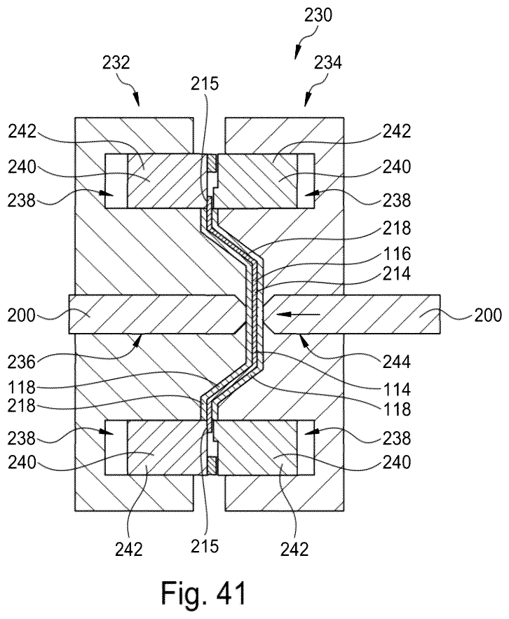

Through both feed zones 236 and 244, additional plastic melt 200 may be pressed into the two gaps and/or the injection mold may be further closed. In this way it can be ensured that edge zones of the two gaps as well are filled up completely with plastic melt 200, as shown by FIG. 41.

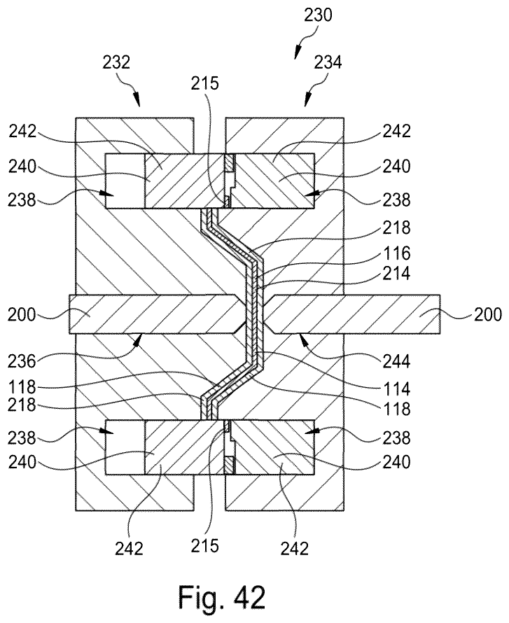

The position of the retaining elements in the guiding zones may be modified. Regions of the shielding material 214 that are arranged between the retaining elements and are not covered with a plastic layer 118 can be separated by punching. This is illustrated by FIG. 42.

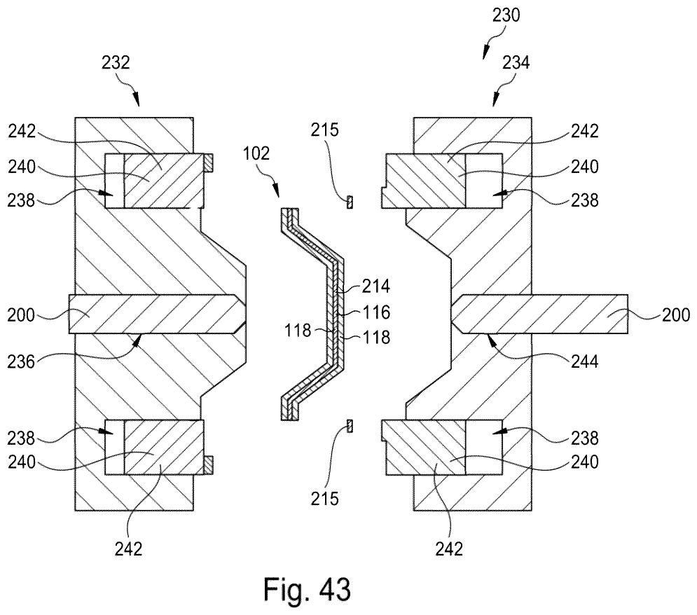

The injection mold 230 can be opened and the resulting protective element 102 withdrawn (FIG. 43).

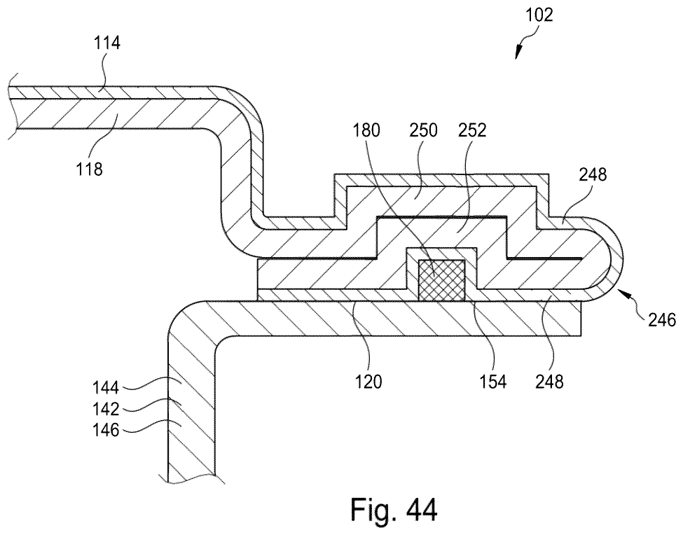

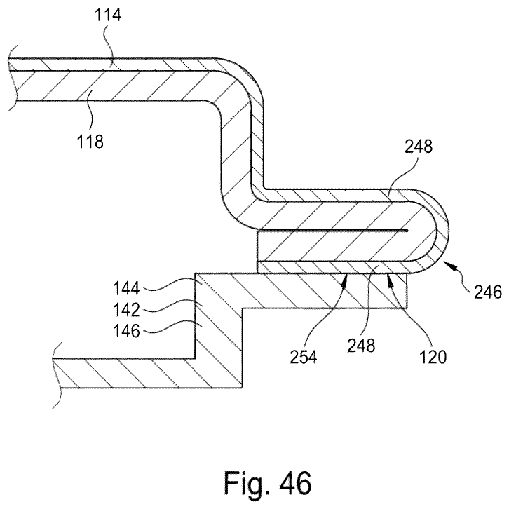

FIGS. 44 to 47 illustrate protective elements 102, wherein the shielding layer 114 comprises a shielding deflection zone 246. In the shielding deflection zone 246, two portions 248 of the shielding layer 114 overlap. One of the two portions 248 forms the contacting zone 120. The contacting zone 120 is an outer-surface contacting zone 154. This is illustrated in particular by FIG. 44 and FIG. 46.

The protective element 102 shown in FIG. 44 differs from the protective element shown in FIG. 46 in particular in that one of the two overlapping portions 248 of the shielding layer 114 extends along a concave zone 250 of the protective element 102, and the other of the two overlapping portions 248 of the shielding layer extends along a convex counterzone 252 of the protective element 102. The convex counterzone 252 is arranged in the concave zone 250.

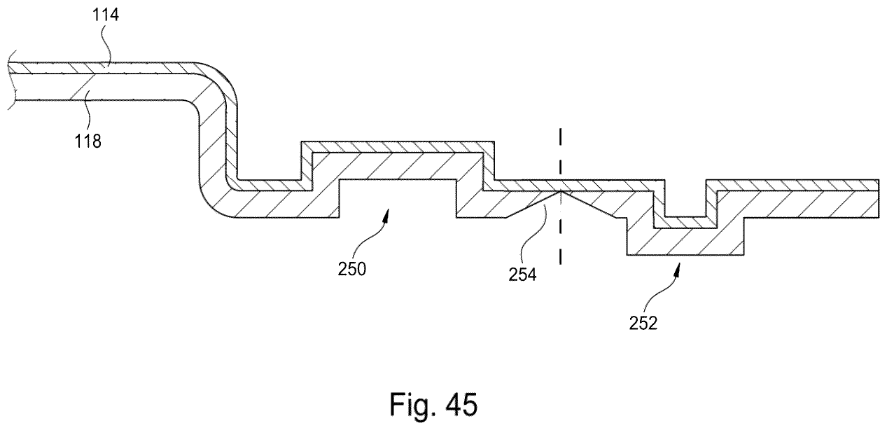

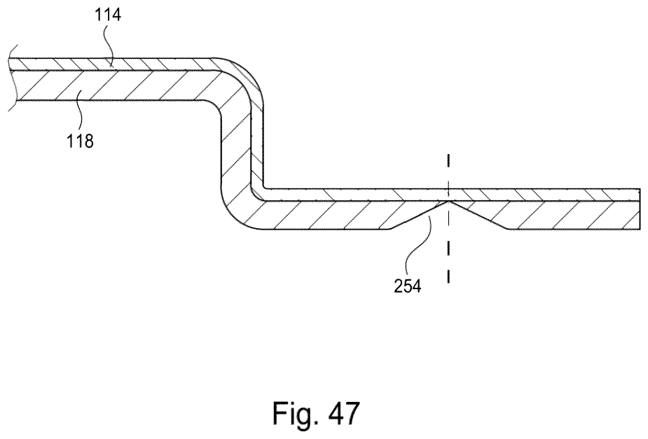

The production of the protective elements 102 with shielding deflection zone 246 which are shown in FIGS. 44 and 46 is illustrated in FIGS. 45 and 47. A layered assembly can be provided, comprising a shielding layer and a plastic layer. The layered assembly may have a cutout zone 254, in which the plastic layer may for example be embodied with interruption or as substantially thinner. The cutout zone 254 may enable the shielding layer 114 to be bent round, that is may enable the production of a shielding deflection zone. The shielding layer is preferably bent round with an approximate U shape in the cutout zone. If the concave zone 250 and the convex counterzone 252 are configured at a suitable distance from the cutout zone 254, the convex counterzone 252 can come to lie in the concave zone 250 when the shielding layer 114 is bent round. This becomes clear from FIG. 45.

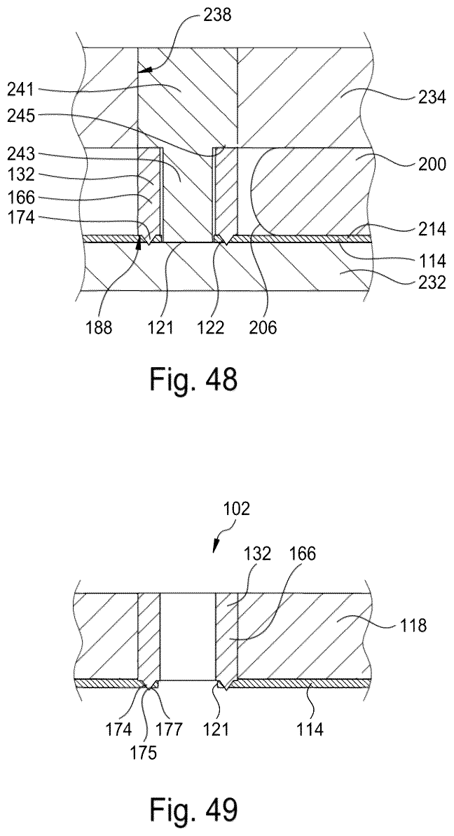

FIGS. 48-93 illustrate diverse possibilities for forming contacting zones 120 through the additional use of contacting elements 132 in a shaping method which may be carried out, for example, according to the principle shown in FIG. 18 or else according to the principle shown in FIGS. 35-43. In this case, modified mold halves 232 and 234 may be used. These mold halves may have die elements 241 and/or punch elements 262 guided in guiding zones 238. Alternatively or additionally, the modified mold halves 232 or 234 may have recesses for accommodating contacting elements 132.

FIGS. 48, 52, 53, 55, 57, 59, 60, 62, 63, 65, 66, 68, 69, 71, 72, 74, 75, 77, 79 and 80 in particular show how, in order to incorporate a contacting element 132 in methods for producing a protective element 102, a die element 241 can be guided in a guiding zone 238 or a contacting element 132 can be accommodated in a recess in a mold half 232 or 234.

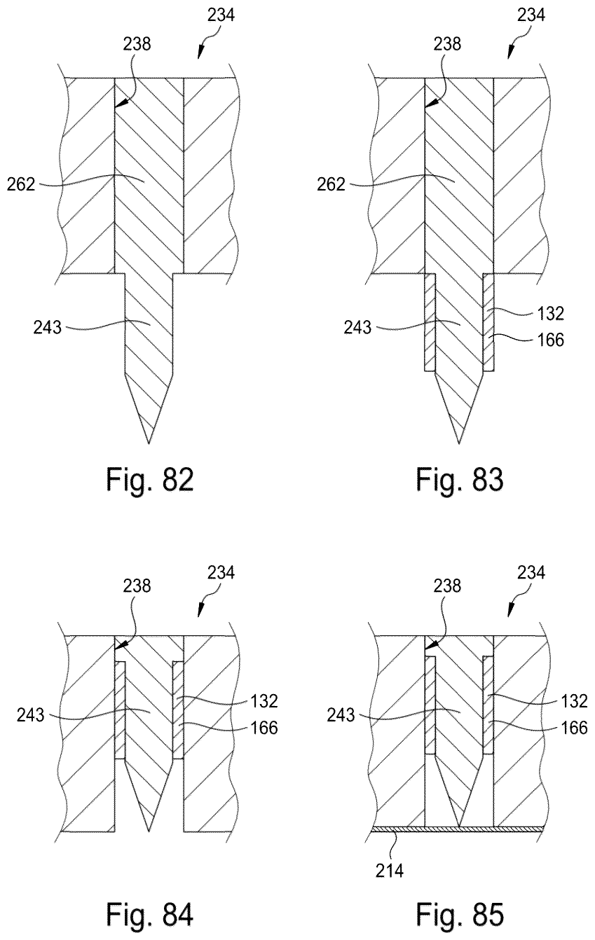

FIGS. 82-93 show how a punching element 262 guided in a guiding zone 238 may be used for introducing a passage opening 121 into a shielding material 214.

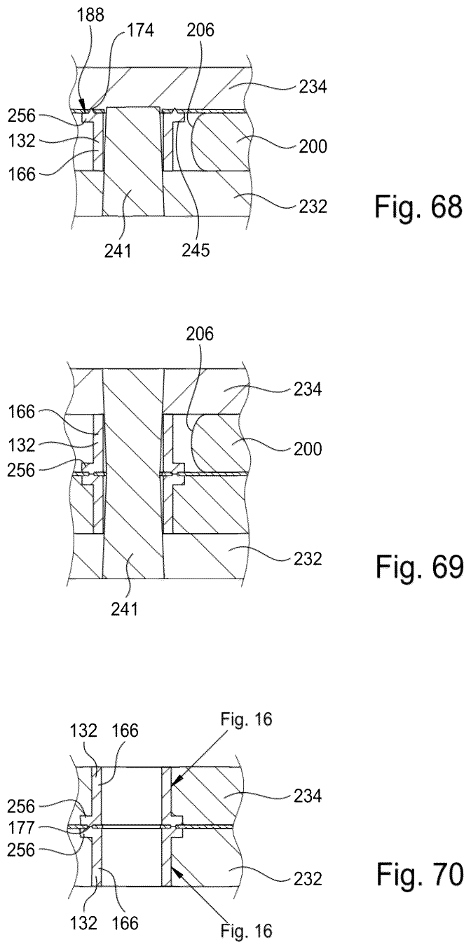

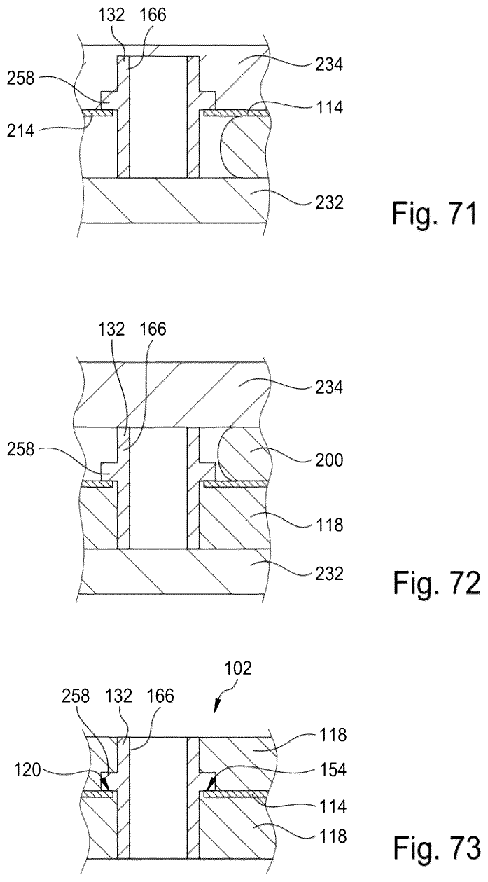

With all of the possibilities that are illustrated in FIGS. 48-93, it is possible, during the formation of a plastic layer 118, for the annular contacting element 132, which may be a sleeve 166, for example, to be embedded at least partially into the resultant plastic layer 118. In that case, the contacting element 132 is arranged, for example, on a surface of the shielding material 214. The contacting element 132 here may be positioned at a desired point using the die element 241 or the punch element 262 (see, in particular, FIGS. 48, 53, 55, 57, 59, 60, 62, 63, 65, 66, 68, 69, 88-93) or accommodated partially in a recess in a mold half 232 or 234 (see, in particular, FIGS. 71, 74, 79) or anchored in a layer, e.g. plastic layer 118, formed in a preceding method step (see, in particular, FIGS. 72, 75, 80). The plastic melt 200 is then conveyed in that direction such that the front 206 of the spreading plastic melt 200 is able to spread over the contacting element 132. This allows the contacting element 132 to be embedded into the resultant plastic layer 118.

In the case of the method illustrated in FIG. 48, the die element 241 comprises a shoulder 245 and an extent element 243 which extends beyond the shoulder 245. The contacting element 132 is taken up onto the extent element 243. A diameter of the extent element 243 is adapted to the internal diameter of the contacting element 132. At an end-face surface 188, the contacting element 132 comprises a plurality of protrusion elements 174. The contacting element 132 is held with the die element 241 on the surface of the shielding material 214. The contacting element 132 is pressed with the die element 241 against the surface of the shielding material 214. The protrusion elements 174 are impressed into the surface of the shielding material 214. In the resulting protective element, of which a detail is shown in FIG. 49, the tips of the protrusion elements 174 respectively form a protrusion element overhang 175, which penetrates the shielding layer 114 and is able to reinforce or stabilize contact with a device, as a contact-reinforcing element 177.

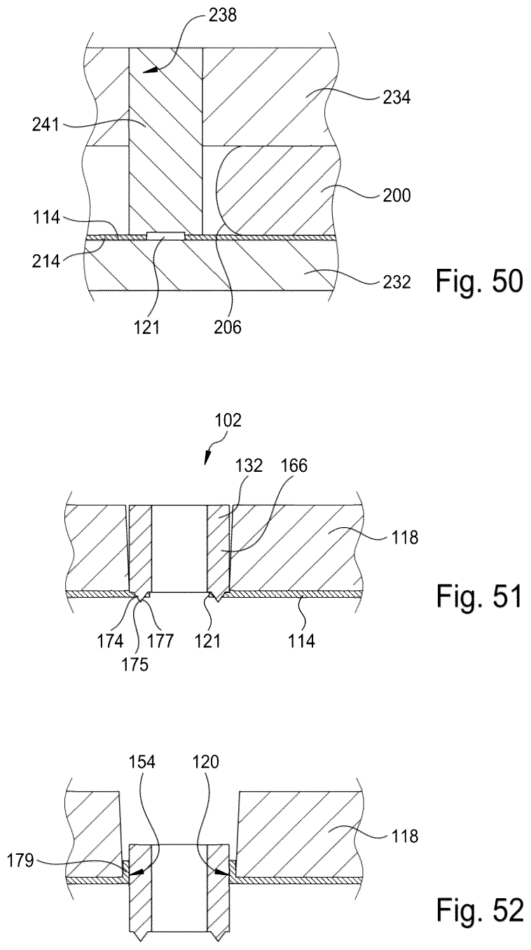

FIG. 50 illustrates a possibility for producing the protective element 102 shown in FIG. 51. A die element 241 guided in a guiding zone 238 occupies a space here, around which the plastic melt 200 spreads. In a downstream step, the contacting element 132 can be introduced into the space and the shielding material 214 can be pierced with the protrusion elements 174 of said contacting element. In contrast to the protective element shown in FIG. 49, the contacting element 132 in the case of the protective element 102 shown in FIG. 51 is not materially bonded with the plastic layer 118. It is alternatively possible, indicated in FIG. 52, to bend an initially formed shielding layer overhang 179 into the space made with the die element 241, allowing an outer-surface contacting zone 154 to come into contact with an outer lateral surface of the contacting element 132 when the contacting element 132 is introduced into the space.

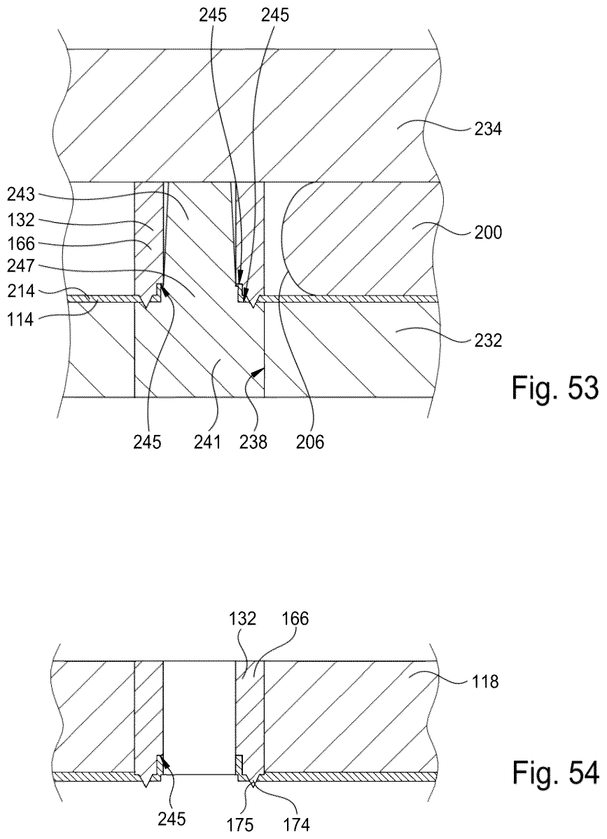

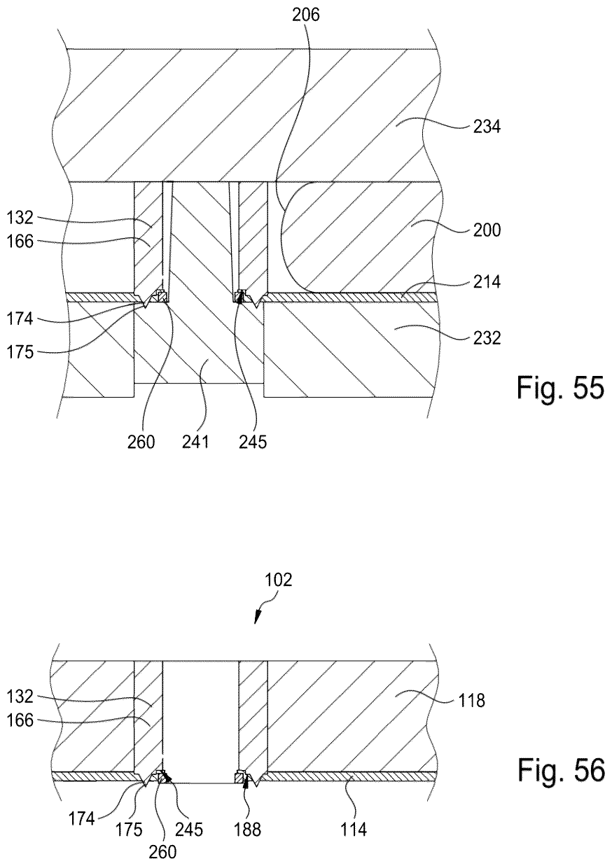

If the contacting element 132 and the die element 241 have shoulders 245 matched with an accurate fit to one another, a shielding material 214 can be introduced between the die element 241 and the contacting element 132 and reshaped between the shoulders 245. Additionally, the die element 245 can be pressed on so firmly that the protrusion elements 174 pierce the shielding material 214 (FIGS. 53 and 54). Arranged on a shoulder 245 of the die element 241, there may be an auxiliary ring element 260 which, after the die element 241 has been pressed onto the shielding material 214, can come to lie on a shoulder 245 of the contacting element 132 that is lined with the shielding material (FIGS. 55 and 56).

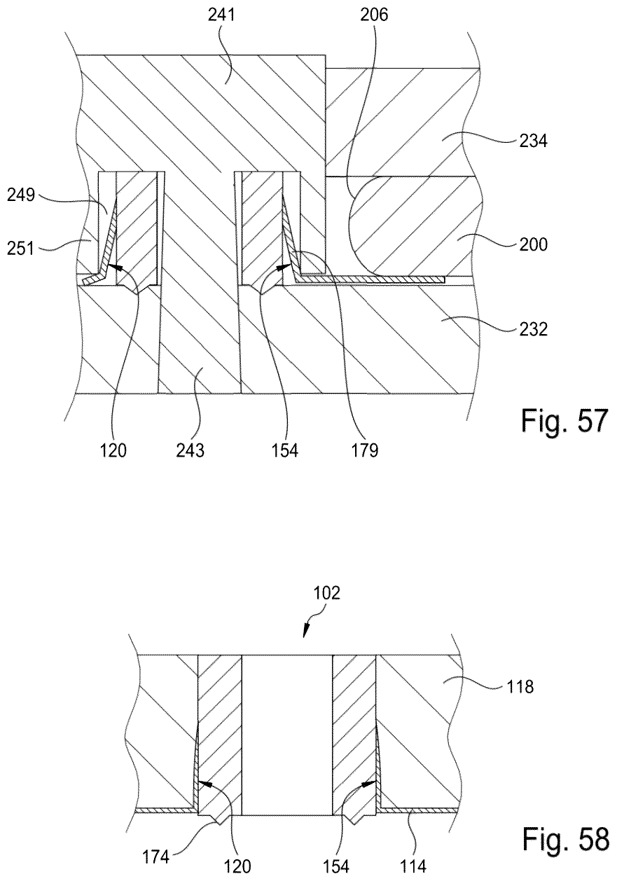

FIG. 57 shows a possibility wherein a die element 241 can have a die recess 249 which may be radially outwardly limited by an annular projection 251. A shielding material 214 may extend through the die recess 249. This material can be clamped between a contacting element 132 and the die element 241 in the die recess 249 and reshaped by a movement of the die element 241. After the plastic layer 118 has been attached, a contacting zone 120 of the shielding layer 114 is in electrically conductive contact with an outer lateral surface of the contacting element 132. The contacting zone 120 is an outer-surface contacting zone 154. In the region of the contacting zone, the shielding layer 114 is pressed through the plastic layer 118 onto the surface of the contacting element 154 (FIG. 58).

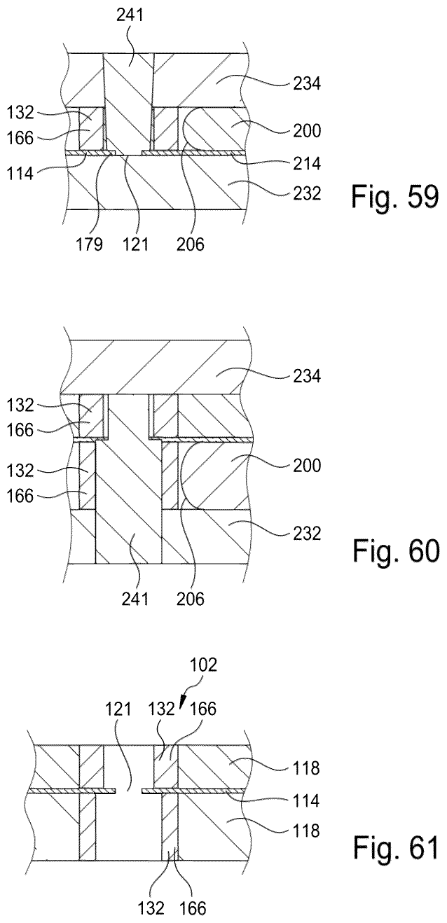

FIGS. 59-70 show possibilities for producing protective elements 102 which comprise at least one contacting element 132 respectively on both sides of the shielding layer 114.

In this case, on one side of a shielding material 214 in each case, a first contacting element 132 is held by a die element 241, which engages into the contacting element 132, and then a plastic melt 200 is spread flatly around the contacting element 132 such that a material bond can be produced between the resultant first plastic layer 118 and the contacting element 132.

Moreover, on the other side of the shielding material 214, a second contacting element 132 is held by a die element 241, which engages into the contacting element 132, and then a further plastic melt 200 is spread flatly around the second contacting element 132 such that a material bond can be produced between the resultant second plastic layer 118 and the contacting element 132.

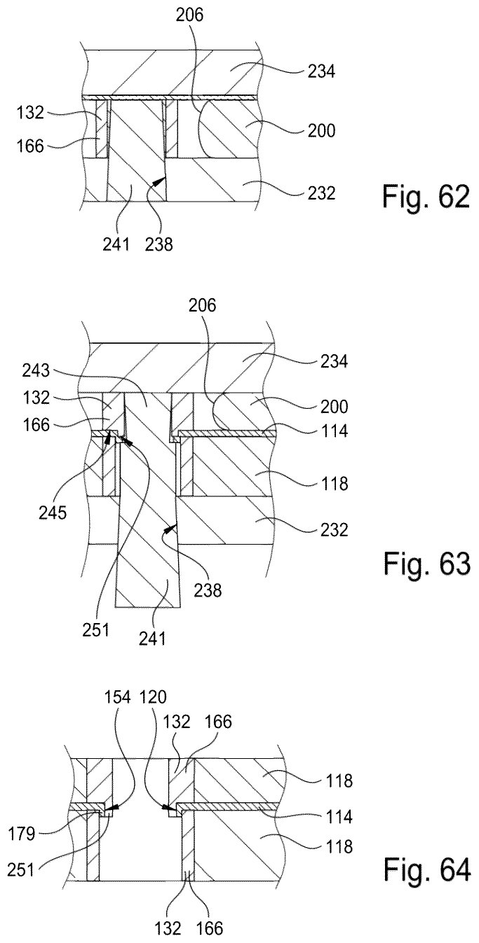

Here, on an end-face surface 188 of a contacting element 132, a shoulder and an annular projection 251 may be configured such that the shielding material 214 can be clamped between the annular projection 251 and the other contacting element 132 (see FIGS. 62-64).

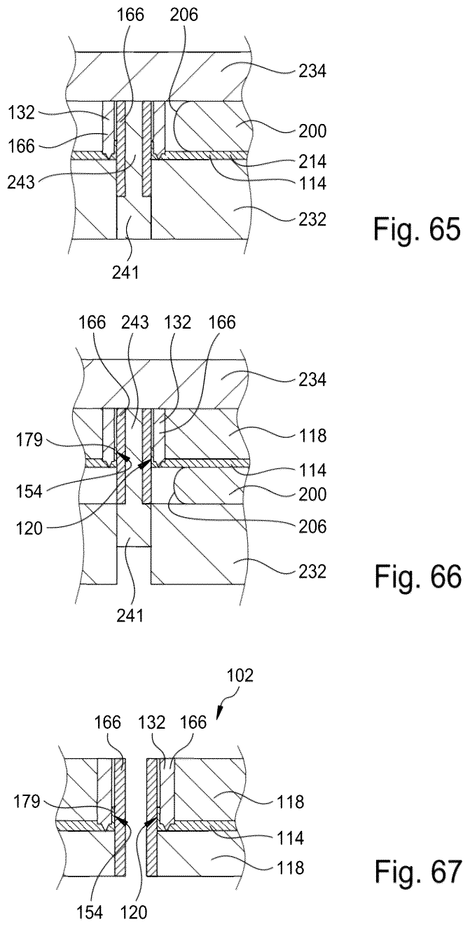

One of the contacting elements 132 may be radially external. The other contacting element 132, which may also be a sleeve 166 which need not be electrically conductive, may be radially internal. A shielding layer overhang may extend into an intervening gap (FIGS. 65-67).

The shielding layer 114 may lie between the mutually facing end-face surfaces of the two contacting elements 132. Protrusion elements 174 which may be arranged on the mutually facing end-face surfaces of both contacting elements 132 may preferably be pressed onto the shielding layer 114 or penetrate the shielding layer 114. The contacting elements 132 may comprise flange zones 256. The protrusion elements 174 may be configured on the flange zones 256 (FIGS. 68-70 and FIG. 16).

FIGS. 71 and 72 illustrate a possibility for producing the protective element 102 shown in FIG. 73. The mold half 234 comprises a recess in which a part of the contacting element 132 is accommodated (FIG. 71). The recess is matched to the shape of the contacting element 132, which on its outer lateral surface comprises a radially outwardly extending crown ring zone 258. It is evident from FIG. 71 that the crown ring zone 258 is likewise accommodated in the recess.

A first plastic layer is produced around the contacting element 166 between the shielding material 214 and the mold half 232 shown at the bottom in FIG. 71. A second plastic layer is subsequently produced around the contacting element 166 between the shielding material 214 and the mold half 24 shown at the top in FIG. 72.

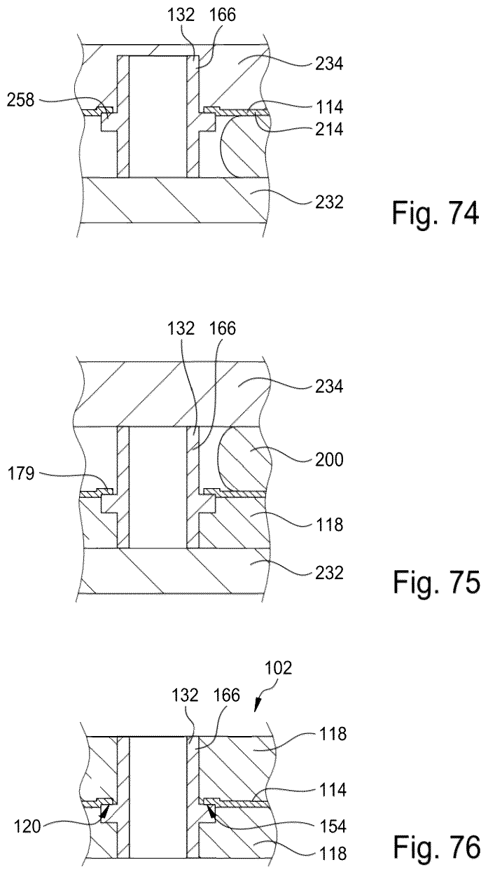

FIGS. 74 and 75 illustrate a possibility for producing the protective element 102 shown in FIG. 76. The procedure is as shown in FIGS. 71 and 72 and is described in association with these two figures; however, the recess is not configured for accommodating the crown ring zone 258, and the shielding material 214 comes to lie on the other side of the crown ring zone 258.

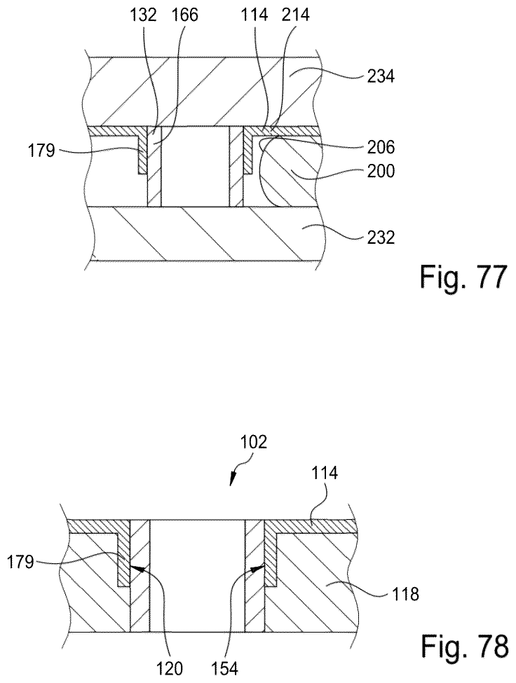

FIG. 77 illustrates a possibility for producing the protective element 102 shown in FIG. 78. A shielding layer overhang 179 is arranged on an outer lateral surface of the contacting element 132. The plastic melt 200 is then spread around the contacting element 132, so that the resulting plastic layer 118 presses a contacting zone 120, which is configured on the shielding layer overhang 179 and is an outer-surface contacting zone 154, onto the outer lateral surface and is consequently able to promote or stabilize electrical contact.

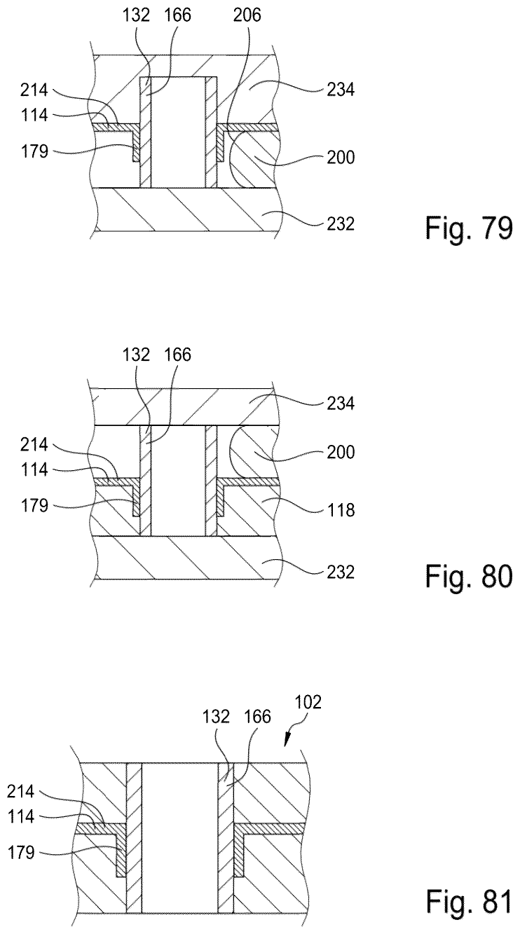

FIGS. 79 and 80 illustrate a possibility for producing the protective element 102 shown in FIG. 81. The procedure in this case is as described in connection with FIGS. 77 and 78. However, a longer contacting element 132 is used, which is first accommodated in a recess in a mold half 234 and after the production of the first plastic layer 118 is accommodated by a second plastic melt 200.

FIG. 82 shows a punch element 262 guided in a guiding zone 238 of a mold half 234. The punch element 262 comprises an extent element 243.

FIG. 83 shows the punch element 262 guided in the guiding zone 238 of the mold half 234, with the extent element 243 extending through a contacting element 132 which is a sleeve 166.

FIG. 84 corresponds to the representation from FIG. 83, with the punch element 262 being represented in a different position in the guiding zone. The tip of the punch element does not protrude from the guiding zone 238.

FIG. 85 corresponds to the representation from FIG. 84. Additionally shown is a shielding material 214 lying against the mold half 234.

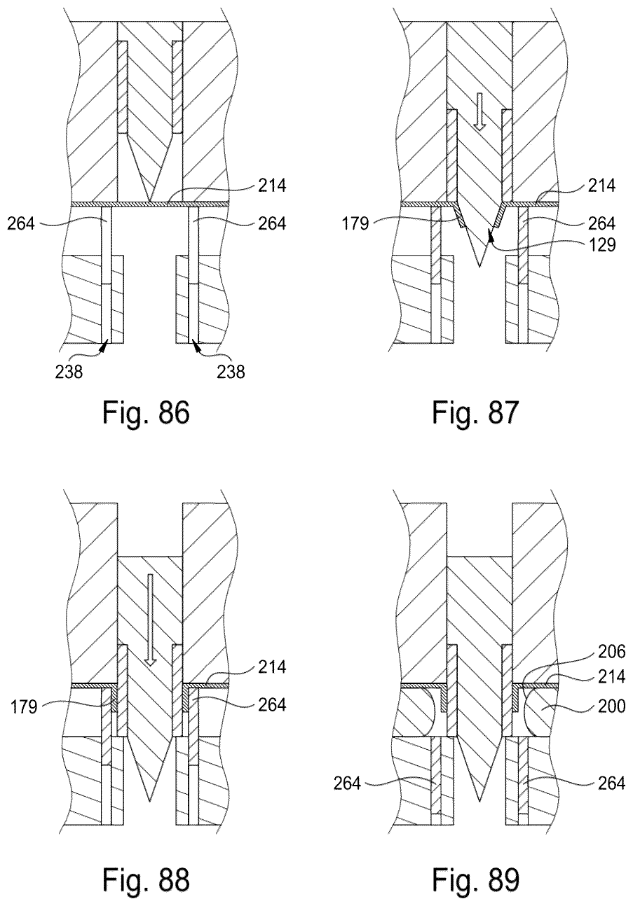

Additionally to FIG. 85, FIG. 86 also shows a further mold half 232. The latter comprises guiding zones 238 for counterhold elements 264. The counterhold elements 264 are able to press the shielding material 214 against the mold half 234 against which the shielding material 214 is lying.

FIG. 87 shows the formation of a passage opening 121 in the shielding material 214. The passage opening 121 comes about by the punch element 262 in the guiding zone 238 being moved up to the shielding material 214 and, with its tip, being moved through the shielding material. This results in a shielding layer overhang 179 on one edge of the passage opening 121.

FIG. 88 shows that on continuation of the movement of the punch element 262, the contacting element 132 is guided partially through the passage opening 121. The contacting element sits on a surface of the mold half 232. A shielding layer overhang 179 is arranged here on an outer lateral surface of the contacting element 132.

FIG. 89 shows how subsequently the plastic melt 200 is spread around the contacting element 132.

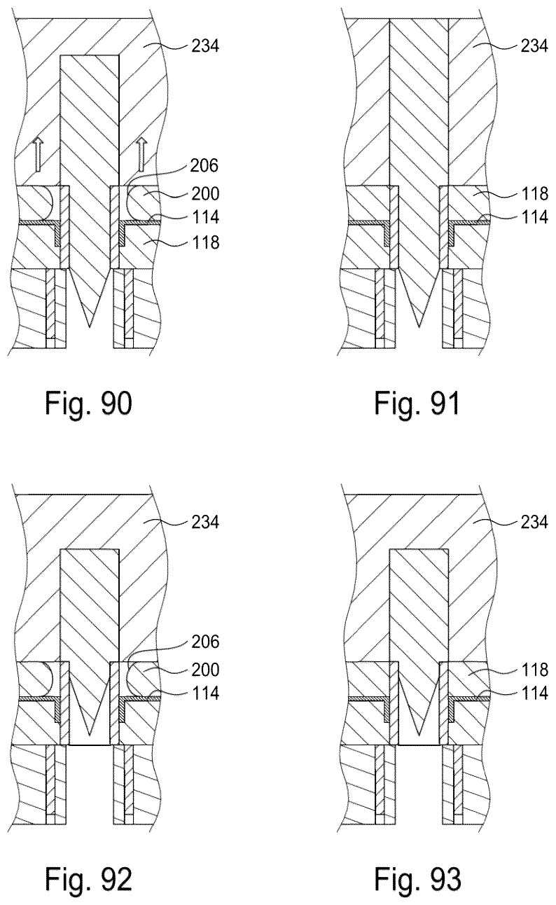

FIG. 90 shows the spreading of a second plastic melt 200 on the other side of the shielding material 114, with the state shown in FIG. 91 being attained.

FIGS. 92 and 93 show a possibility for producing the second plastic layer 118 with a different mold half 234.

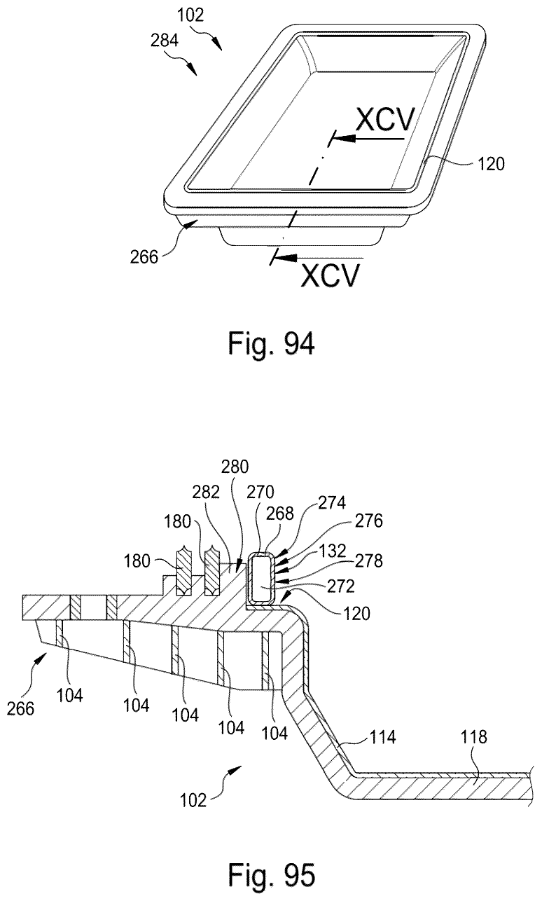

FIG. 94 shows a protective element 102, in a greatly simplified representation; said protective element may be, for example, a casing tray 284 for an electrochemical energy storage device of a motor vehicle, for example for a high-voltage battery device.

In FIG. 94, a contacting zone 120 and a reinforcing unit 266 of the protective element 102 are also shown.

FIG. 95 shows a section of the protective element 102 from FIG. 94 along the line XCV-XCV, with further details being shown in the section.

The contacting element 132 represented additionally in FIG. 95 is deformable and elastic. The contacting element 132 comprises fibers 268 which are contained in a fibrous material 270.

The fibrous material 270 of the contacting element 132 extends around a compression zone 272. During assembly of the protective element 102 on a motor vehicle, the contacting element 132 may be deformed, in which case the contacting element 132 and its compression zone 272 are compressed, for example squashed, in particular in the assembly direction.

The contacting element 132 shown is a hollow contacting element 274 through which the compression zone 272 extends. The contacting element 132 may be, for example, a fiber material hose 278, e.g. a woven fabric hose 276.

The protective element 102 comprises a positioning and/or aligning element 280, which in the example shown here is a positioning and/or aligning projection 282. The positioning and/or aligning element 280 is arranged on the contacting zone 120.

The fiber material hose 278, e.g. the woven fabric hose 276, is arranged on the positioning and/or aligning element 280, e.g. on the positioning and/or aligning projection 282, and on the contacting zone 120.

### LIST OF REFERENCE SIGNS

100 aluminum component
102 protective element
104 reinforcing rib
106 battery casing part
108 underbody protection element
109 shielding component
110 insulation layer
112 casing component
114 shielding layer
116 aluminum foil
118 plastic layer
120 contacting zone
121 passage opening
122 inner-surface contacting zone
124 reinforcing layer
126 fibers
128 organic sheet
130 protective layer
132 contacting element
133 connecting element
134 component set
136 screw
138 thread
140 shielding layer end face
142 mass
144 carrier structure
146 frame
148 plastic core
150 capping ply
152 capping layer
154 outer-surface contacting zone
156 outer surface
158 offset zone
160 insulation zone
164 adhesion promoter
166 sleeve
168 contacting element
170 flow-hole screw
172 protrusion zone
174 protrusion element
175 protrusion element overhang
176 bead
177 contact-reinforcing element
178 recess
179 shielding layer overhang
180 sealing element
182 washer
184 bridging element
186 discharge element
188 end-face surface
190 shaping method
192 compression molding method
194 shaping tool
196 compression mold
198 cavity
200 plastic melt
202 shaping element
204 compression molding element
206 front
208 overlap portion
210 overhang portion
212 offsetting force
214 shielding material
215 edge
218 plastic
220 securement arrangement
224 reinforcing ply
230 injection mold
232, 234 mold half
236, 244 feed zone
238 guiding zone
240 retaining element
241 die element
242 punching element
243 extent element
245 shoulder
246 shielding deflection zone
247 transition zone
248 portion
249 die recess
250 concave zone
251 annular projection
252 convex counterzone
254 cutout zone
256 flange zone
258 crown ring zone
260 auxiliary ring element
262 punch element
264 counterhold element
266 reinforcing unit
268 fibers of the contacting element
270 fibrous material
272 compression zone
274 hollow contacting element
276 woven fabric hose
278 fiber material hose
280 positioning and/or aligning element
282 positioning and/or aligning projection
284 casing tray

1. A protective element for arrangement on a device which emits electromagnetic radiation or an at least partially electrically powered motor vehicle, the protective element comprising:
a shielding layer for shielding from electromagnetic radiation,
a plastic layer; and
a contacting zone by means of which electrical contact can be produced between the shielding layer and the device or said at least partially electrically powered motor vehicle.

2. The protective element as claimed in claim 1, wherein the shielding layer is arranged between the plastic layer and an electrically insulating protective layer.

3. The protective element as claimed in claim 1, wherein the protective element comprises a contacting element,
wherein by means of the contacting element electrical contact can be producible or stabilizable between the contacting zone and the device
and/or
wherein electrical contact bridged by the contacting element can be producible between the contacting zone and the device.

4. The protective element as claimed in claim 3, wherein the contacting element is deformable and/or elastic.

5. The protective element as claimed in claim 3, wherein the shielding layer comprises a shielding layer overhang,
wherein the shielding layer overhang comprises the contacting zone, and
wherein the shielding layer on the shielding layer overhang is not covered by the plastic layer and/or, if the protective element is embedded between the plastic layer and a further layer or a second plastic layer is not covered by at least one of these two layers.

6. The protective element as claimed in claim 3, wherein at least part of the shielding layer overhang extends in a different direction than a part of the shielding layer that is covered by the plastic layer, and
wherein at least part of the shielding layer overhang is in contact with an outer lateral surface of the annular contacting element.

7. The protective element as claimed in claim 1, wherein the contacting zone is configured on a shielding layer end face.

8. The protective element as claimed in claim 3, wherein the shielding layer comprises a passage opening, and/or wherein the passage opening is able to align with an opening in the annular contact element.

9. The protective element as claimed in claim 1, wherein the contacting zone is an outer-surface contacting zone, and wherein the outer-surface contacting zone is configured on an outer surface of the shielding layer.

10. The protective element as claimed in claim 9, wherein the protective element comprises:
an offset zone,
wherein the shielding layer extends in a different direction in the offset zone than in the contacting zone.

11. The protective element as claimed in claim 9, wherein, in the contacting zone, the shielding layer forms a capping layer of the protective element.

12. The protective element as claimed in claim 10, wherein, in a further zone, separated from the contacting zone by the offset zone or in an insulation zone a layer of the protective element different from the shielding layer or the electrically insulating protective layer, forms a capping layer of the protective element.

13. The protective element as claimed in claim 1, wherein the protective element is fiber-reinforced.

14. The protective element as claimed in claim 13, wherein the plastic layer comprises fibers.

15. The protective element as claimed in claim 14, wherein the fibers are dispersed in a plastic material of the plastic layer, and wherein a mean length of the fibers is 1 mm to 40 mm or 2 mm to 20 mm.

16. The protective element as claimed in claim 1, wherein the protective element comprises a reinforcing layer, and wherein the reinforcing layer comprises a laid fiber scrim or a uniaxial or a multiaxial scrim or a woven fiber fabric.

17. The protective element as claimed in claim 1, wherein the protective element is a protective sandwich element, wherein the protective sandwich element comprises a reinforcing layer respectively on both surfaces, and/or wherein the two reinforcing layers independently of one another comprise a laid fiber scrim or a uniaxial or a multiaxial scrim or a woven fiber fabric.

18. A component set for arrangement on the device which emits electromagnetic radiation or the at least partially electrically powered motor vehicle, the component set comprising:
the protective element as claimed in claim 1; and
the contacting element which is in electrically conductive contact with the contacting zone.

19. A method for producing the protective element as claimed in claim 1, wherein a ply of a shielding material is provided and a plastic layer is formed in the layered assembly with the shielding material, wherein the shielding material
is at least partially reshaped prior to the formation of the plastic layer; and/or
is at least partially reshaped during the formation of the plastic layer; and/or
is at least partially reshaped after the formation of the plastic layer, in the layered assembly,
wherein a second layer is formed in the layered assembly with the shielding material concurrently with the formation of the plastic layer, temporally overlapping the formation of the plastic layer or temporally offset from the formation of the plastic layer, and/or
wherein a contacting zone is formed by means of which electrical contact is produced between the shielding layer formed from the shielding material and the device which emits electromagnetic radiation.

20. The method as claimed in claim 19, wherein the method comprises a compression molding method, wherein
a) an arrangement comprising:
the ply of the shielding material,
a second ply serving to form the second layer or a reinforcing ply, and
a plastic arranged between these plies and serving to form the plastic layer or a plastic which is moldable by compression molding,
is provided in an open cavity of a shaping tool, and
b) a shape of the protective element is at least partially defined by closing the shaping tool, by building up an elevated pressure and/or by supplying heat, wherein the shielding material is at least partially reshaped, and
c) the shaping tool is opened and the protective element or a protective element precursor is removed from the open cavity of the shaping tool.

21. The method as claimed in claim 19, wherein the method comprises an injection molding method, wherein
a) the ply of the shielding material is positioned between two mold halves of an injection mold,
b) a shape of the shielding material, desired for the protective element, is defined in the injection mold by reshaping,
c) the plastic layer or a layer of melted plastic, is applied on at least one of the two surfaces of the shielding material, and
d) a plastic layer or the layer of melted plastic, is applied on the other of the two surfaces of the shielding material.
